(19) United States
(12) Patent Application Publication
(10) Pub. No.: US 2026/0045983 A1
(43) Pub. Date: Feb. 12, 2026

(54) ANTENNA SELECTION FOR DATA TRANSMISSION AND TUNER STATE SELECTION FOR RECEPTION OPTIMIZATION BY A MULTI-ANTENNA USER EQUIPMENT (UE)

(71) Applicant: Apple Inc., Cupertino, CA (US)

(72) Inventors: Wen Zhao, Cupertino, CA (US); JungHyun Park, Cupertino, CA (US); Junhong Zhang, Santa Clara, CA (US); Kexin Ma, San Diego, CA (US); Mihir Hemant Bhavsar, San Diego, CA (US); Wisuit Sinsathitchai, San Jose, CA (US); Zhengbo Zhu, San Diego, CA (US)

(73) Assignee: Apple Inc., Cupertino, CA (US)

(21) Appl. No.: 18/796,228

(22) Filed: Aug. 6, 2024

(51) Int. Cl. H04B 7/06; H04B 17/10

(52) U.S. Cl. CPC H04B 7/0608; H04B 17/101

(57) ABSTRACT

The present application relates to selecting an antenna optimization parameter of a UE. In an example, grip data indicating a user grip of the UE is generated. The grip data is used in a look-up of antenna data indicating an antenna selection from the plurality of antennas and/or a tuner state from a plurality of tuner states. In another example, reference signal measurements can be generated, each corresponding to one of the antennas. The reference signal measurements can be input to artificial intelligence model that outputs the antenna selection, the tuner state, or a predicted angle of arrival. The predicted angle of arrival can be used in a look-up of antenna data to determine the antenna selection and/or the tuner state.

### BACKGROUND

Cellular network coverage can enable communications between a user equipment (UE) and a cellular network. Generally, a cellular network (e.g., a base station thereof) sends downlink data to the UE. Conversely, the UE sends uplink data to the cellular network. Frequency division duplexing (FDD) and time division duplexing (TDD) are techniques available for the reception and transmission. Such techniques can be implemented at least in part by a radio frequency (RF) front end of the UE.

### BRIEF DESCRIPTION OF THE DRAWINGS

FIG. 1 illustrates a network environment, in accordance with some embodiments.

FIG. 2 illustrates an example of a multi-antenna user equipment (UE), in accordance with some embodiments.

FIG. 3 illustrates examples of data reception and data transmission by a multi-antenna UE, in accordance with some embodiments.

FIG. 4 illustrates an example of a user grip of a multi-antenna UE, in accordance with some embodiments.

FIG. 5 illustrates an example of a plot showing performances of different antenna selection techniques, in accordance with some embodiments.

FIG. 6 illustrates an example of antenna selections across different signal angle of arrivals, in accordance with some embodiments.

FIG. 7 illustrates an example of an antenna selection, in accordance with some embodiments.

FIG. 8 illustrates an example of an operational flow/algorithmic structure implemented by a UE to determine a user grip, in accordance with some embodiments.

FIG. 9 illustrates another example of an operational flow/algorithmic structure implemented by a UE to determine a user grip, in accordance with some embodiments.

FIG. 10 illustrates an example of an operational flow/algorithmic structure implemented by a UE to select an antenna and/or a tuner state, in accordance with some embodiments.

FIG. 11 illustrates another example of an operational flow/algorithmic structure implemented by a UE to select an antenna and/or a tuner state, in accordance with some embodiments.

FIG. 12 illustrates yet another example of an operational flow/algorithmic structure implemented by a UE to select an antenna, in accordance with some embodiments.

FIG. 13 illustrates an example of an operational flow/algorithmic structure for training an artificial intelligence (AI) model for antenna selection and/or tuner state selection, in accordance with some embodiments.

FIG. 14 illustrates an example of an operational flow/algorithmic structure implemented by a UE to exchange data, in accordance with some embodiments.

FIG. 15 illustrates another example of an operational flow/algorithmic structure implemented by a UE to exchange data, in accordance with some embodiments.

FIG. 16 illustrates an example of receive components, in accordance with some embodiments.

FIG. 17 illustrates an example of a UE, in accordance with some embodiments.

FIG. 18 illustrates an example of a base station, in accordance with some embodiments.

### DETAILED DESCRIPTION

Embodiments of the present disclosure are directed to, among other things, selecting and using an optimal antenna from a plurality of antennas of a user equipment (UE). The selected antenna can be used for data transmission and may be different from another antenna of the UE used for data reception. Generally, an optimal transmitting antenna can be selected when an angle of arrival of a signal (referred to herein as a signal angle of arrival (AoA)) is known. Typically, however, the signal AoA is unknown. As such, an approximation technique is implemented. For reception, an optimal tuner setting is determined based on the UE's operating state.

In an example, the approximation/optimization technique involves determining a user grip, such as whether the UE is not being held, is held with two hands, held in a portrait mode (left or right), or held in a landscape mode (left or right). Given the user grip and, possibly, other factors (e.g., the type of the UE, the frequency band for data transmission, the duplexing technology, etc.), antenna data can be looked up to determine an antenna subset of the plurality of antennas. The antenna data can be predefined using simulations of the signal AoAs and corresponding optimal antenna selections. Particularly, the antenna data can indicate that the antenna subset has the highest likelihood among the plurality of antennas to provide the best performance (e.g., highest possible data throughput, maximum effective isotropic radiated power (EIRP), etc.). If the antenna subset includes only one antenna, that antenna is selected. Otherwise, a reference signal measurement and a transmit power level per antenna of the antenna subset are determined and used to select the antenna from the antenna subset. Similarly, user grip data can be used in a look-up of antenna data to select a tuner state, where this tuner state is associated with a likelihood of providing the best antenna performance from among the plurality of tuner states. The selected tuner state can be used for data reception.

In another example, instead of or in addition to predefined antenna data, an artificial intelligence (AI) model can be used. Particularly, the AI model can be trained to output antenna selections and/or tuner state selections based on reference signal measurements corresponding to the plurality of antenna. Upon a reference signal being received, reference signal measurements can be generated therefrom and input to the AI model. The AI model can output an indication of a user grip state (e.g., no grip, left hand, right hand, which antenna port is being blocked), an antenna selection, and/or a tuner state selection. Possibly, user grip data (if not output by the AI model itself) and other factors (e.g., the type of the UE, the frequency band for data transmission, the duplexing technology, etc.) can be used as part of the input to further enhance the antenna selection accuracy.

The above techniques can provide several technical advantages. For example, the data throughput can be increased because of the antenna selection. Further, the power consumption of a UE can be reduced because the transmit power can be reduced given the antenna selection.

In the interest of clarity of explanation, various embodiments of the present disclosure are described in connection with a new radio (NR) fifth generation (5G) cellular network. However, the embodiments may not be limited as such and can apply to other types of wireless networks including, for instance, fourth generation (4G) cellular networks, sixth generation (6G) cellular networks, WiFi, Bluetooth or any other radio networks.

The following detailed description refers to the accompanying drawings. The same reference numbers may be used in different drawings to identify the same or similar elements. In the following description, for purposes of explanation and not limitation, specific details are set forth, such as particular structures, architectures, interfaces, techniques, etc., in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrase “A or B” means (A), (B), or (A and B).

The following is a glossary of terms that may be used in this disclosure.

The term “circuitry” as used herein refers to, is part of, or includes hardware components, such as an electronic circuit, a logic circuit, a processor (shared, dedicated, or group) or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processing circuitry” as used herein refers to, is part of, or includes circuitry capable of sequentially and automatically carrying out a sequence of arithmetic or logical operations, or recording, storing, or transferring digital data. The term “processing circuitry” may refer to an application processor, a baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The terms “device” and “user equipment (UE)” as used herein refers to a wired and/or wireless computing device with radio communication capabilities and that may use network resources in a communications network. The terms “device” and “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc.

The term “base station” as used herein refers to a device with radio communication capabilities, that is a network component of a communications network (or, more briefly, a network), and that may be configured as an access node in the communications network. A device's access to the communications network may be managed at least in part by the base station, whereby the UE connects with the base station to access the communications network. Depending on the radio access technology (RAT), the base station can be referred to as a gNodeB (gNB), eNodeB (eNB), access point (AP), etc.

The term “network” as used herein reference to a communications network that includes a set of network nodes configured to provide communications functions to a plurality of user equipment via one or more base stations. For instance, the network can be a public land mobile network (PLMN) that implements one or more communication technologies including, for instance, 5G communications.

The term “connected” may mean that two or more elements, at a common communication protocol layer, have an established signaling relationship with one another over a communication channel, link, interface, or reference point.

The term “reference signal” refers to a signal that is predefined and that can be used to generate reference signal measurements. Examples of the reference signal measurements include, but not limited to, reference signal received power (RSRP, received signal strength indicator (RSSI), signal to interference and noise ratio (SINR), and signal to noise ratio (SNR). RSRP is used as an example herein below. However, the embodiments are not limited as such and similarly and equivalently apply to all other reference signal measurement types.

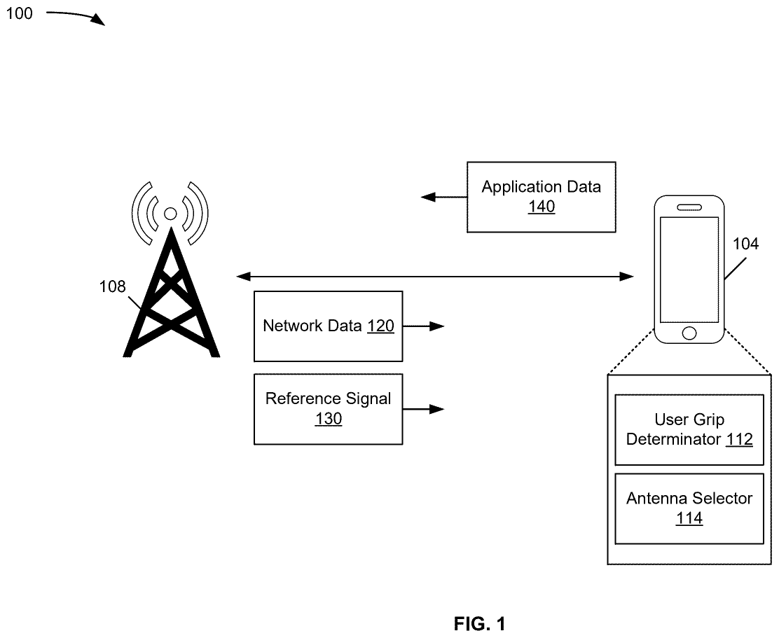

FIG. 1 illustrates a network environment 100, in accordance with some embodiments. As illustrated, the network environment 100 includes a UE 104 and a base station 108. The base station 108 may provide a wireless access cell; for example, a Third-Generation Partnership Project (3GPP) cell (e.g., new radio (NR) 5G cell) through which the UE 104 may communicate with the base station 108. This base station may be a component of a network (e.g., a 3GPP cellular network). The UE 104 and the base station 108 (e.g., a gNB) may communicate over an interface compatible with 3GPP technical specifications.

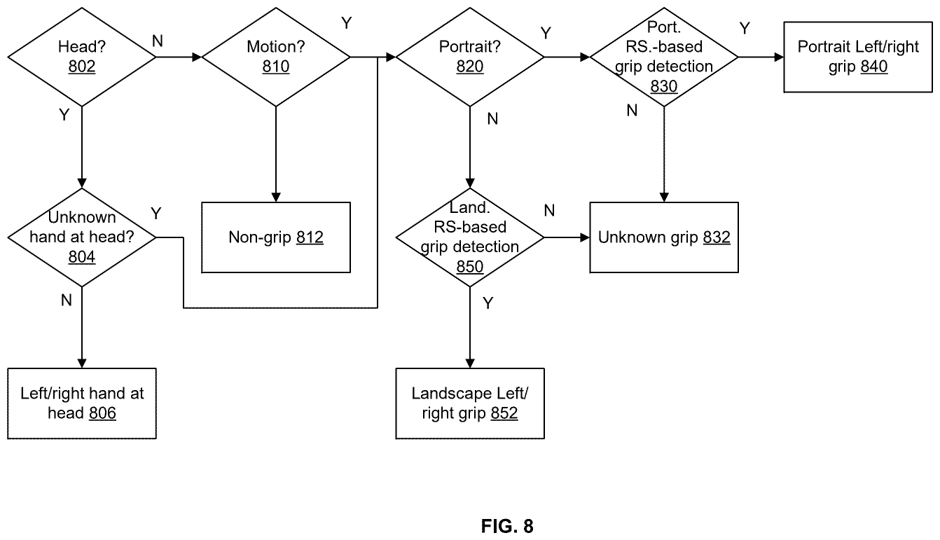

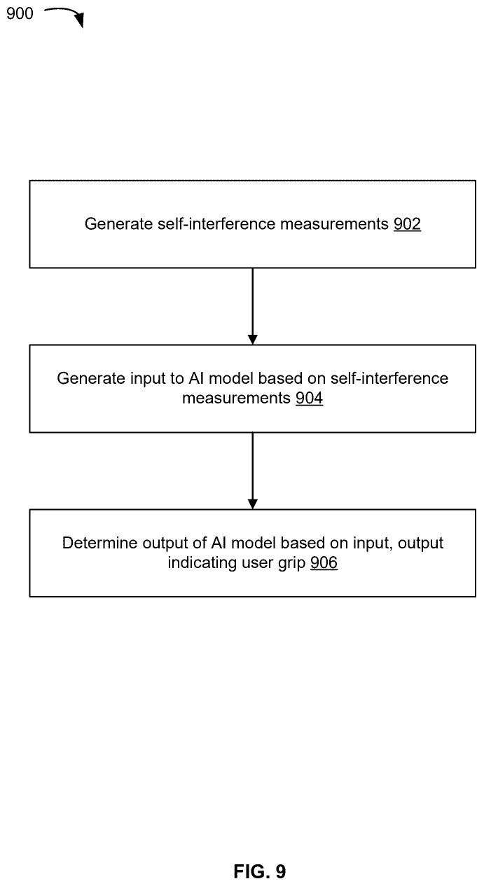

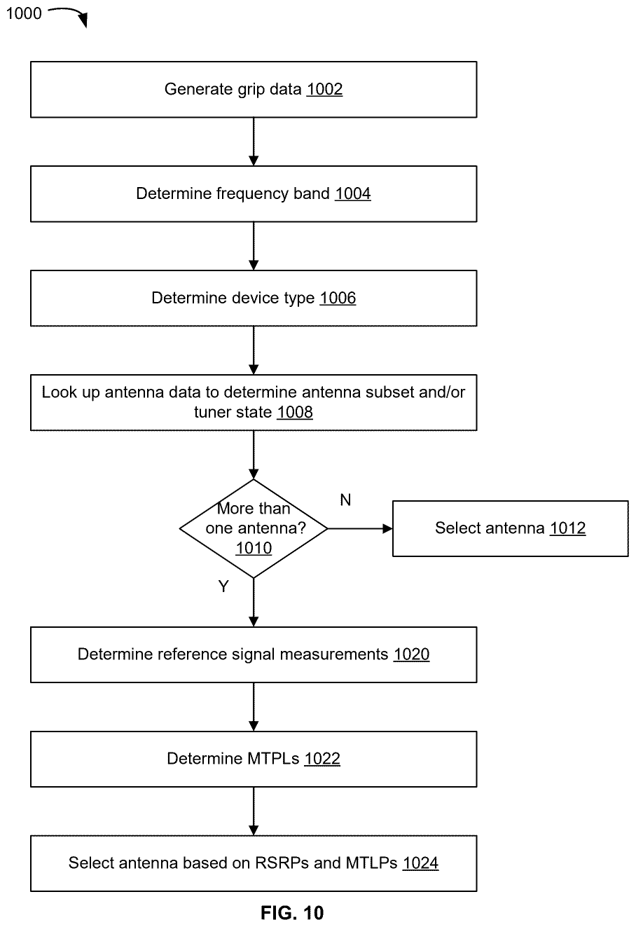

As further described in the next figures, the UE 104 can be a multi-antenna UE and can implement (in hardware and/or software) a user grip determinator 112 and an antenna selector 114. The user grip determinator 112 can process different inputs, as further described in FIGS. 8-9 to generate user grip data indicating a user grip of the UE 104. The antenna selector 114 can also process different inputs, as further described in FIGS. 10-12, among which can be the user grip data and/or reference signal measurements, to select one or more antennas of the plurality of antennas of the UE 104 for data transmission and/or to select one or more tuner states for an antenna used for data reception. The reference signal measurements can be measurements on a reference signal 130 transmitted by the base station 108 and received by the UE 104 (via one or more of the plurality of antennas). An example reference signal measurement can be an RSRP measurement generated from a channel state information reference signal (CSI-RS) or an SS/PBCH block (SSB) signal. RSSI and SINR are other examples reference signal measurements. The antenna selector 114 can indicate the antenna (or antennas) selected for the uplink transmissions to the base station 108 and/or tuner state (or tuner stages) selected for the downlink receptions from the base station 108. Depending on a number of factors, the selected transmission antenna or antennas can be different from the antenna or antennas used for the downlink reception from the base station. As such, it is possible that the UE can receive network data 120 from the base station 108 via a first antenna and can transmit application data 140 via a second antenna (the selected antenna). Generally, the network data can be any traffic data or control data sent by the base station 108. The application data 140 can be any data generated by an application executing on the UE 104 (although, the second antenna can also be used for control data sent by the UE 104).

The base station 108 may transmit information (for example, data and control signaling) in the downlink direction by mapping logical channels on the transport channels, then transport channels onto physical channels. The logical channels may transfer data between a radio link control (RLC) and media access control (MAC) layers; the transport channels may transfer data between the MAC and PHY layers; and the physical channels may transfer information across the air interface. The physical channels may include a physical broadcast channel (PBCH); a physical downlink control channel (PDCCH); and a physical downlink shared channel (PDSCH).

The PBCH may be used to broadcast system information that the UE 104 may use for initial access to a serving cell. The PBCH may be transmitted along with primary synchronization signals (PSS) and secondary synchronization signals (SSS) in a synchronization signal (SS)/PBCH block. The SS/PBCH blocks (SSBs) may be used by the UE 104 during a cell search procedure and for beam selection.

The PDSCH may be used to transfer end-user application data (e.g., the application data 140), signaling radio bearer (SRB) messages, system information messages (other than, for example, MIB), and paging messages.

The PDCCH may transfer downlink control information (DCI) that is used by a scheduler of the base station 108 to allocate both uplink and downlink resources. The DCI may also be used to provide uplink power control commands, configure a slot format, or indicate that preemption has occurred.

The base station 108 may also transmit various reference signals to the UE 104. The reference signals may include demodulation reference signals (DM-RSs) for the PBCH, PDCCH, and PDSCH. The UE 104 may compare a received version of the DMRS with a known DM-RS sequence that was transmitted to estimate an impact of the propagation channel. The UE 104 may then apply an inverse of the propagation channel during a demodulation process of a corresponding physical channel transmission.

The reference signals may also include CSI-RS. The CSI-RS may be a multi-purpose downlink transmission that may be used for CSI reporting, beam management, connected mode mobility, radio link failure detection, beam failure detection and recovery, and fine-tuning of time and frequency synchronization.

The reference signals and information from the physical channels may be mapped to resources of a resource grid. There is one resource grid for a given antenna port, subcarrier spacing configuration, and transmission direction (for example, downlink or uplink). The basic unit of an NR downlink resource grid may be a resource element, which may be defined by one subcarrier in the frequency domain, and one orthogonal frequency division multiplexing (OFDM) symbol in the time domain. Twelve consecutive subcarriers in the frequency domain may compose a physical resource block (PRB). A resource element group (REG) may include one PRB in the frequency domain, and one OFDM symbol in the time domain, for example, twelve resource elements. A control channel element (CCE) may represent a group of resources used to transmit PDCCH. One CCE may be mapped to a number of REGs; for example, six REGs.

The UE 104 may transmit data and control information to the base station 108 using physical uplink channels. Different types of physical uplink channels are possible, including a physical uplink control channel (PUCCH) and a physical uplink shared channel (PUSCH).

Whereas the PUCCH carries control information from the UE 104 to the base station 108, such as uplink control information (UCI), the PUSCH carries data traffic (e.g., end-user application data) and can carry UCI.

In an example, communications with the base station 108 can use channels in the frequency range 1 (FR1) band and/or frequency range 2 (FR2) band, although other frequency ranges are possible. The FR1 band includes a licensed band and an unlicensed band. The NR unlicensed band (NR-U) includes a frequency spectrum that is shared with other types of radio access technologies (RATs) (e.g., LTE-LAA, WiFi, etc.). A listen-before-talk (LBT) procedure can be used to avoid or minimize collision between the different RATs in the NR-U, whereby a device applies a clear channel assessment (CCA) check before using the channel.

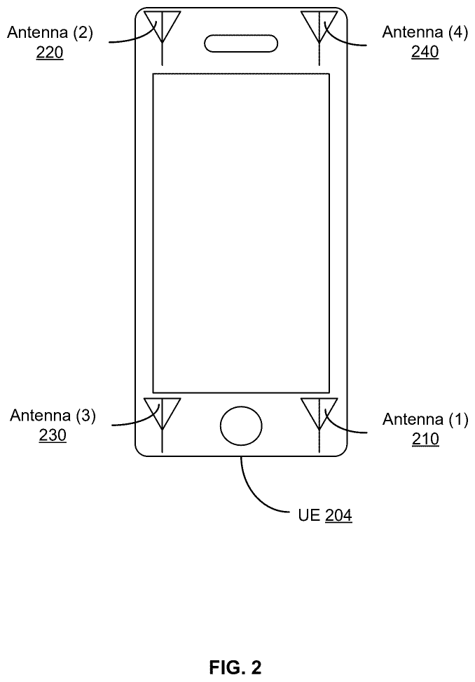

FIG. 2 illustrates an example of a multi-antenna UE 204, in accordance with some embodiments. The multi-antenna UE 204 is an example of the UE 104 of FIG. 1. In the interest of brevity, a multi-antenna UE can be referred to as a UE in the present disclosure. As illustrated, the UE 204 includes four antennas. A first antenna (1) 210 is at the bottom right corner of the UE 204, whereas a second antenna (2) 220 is at the top left corner of the UE 204. Further, a third antenna (3) 230 is at the bottom left corner of the UE 204, whereas a fourth antenna (4) 240 is at the top right corner of the UE 204. Of course, a different number and/or arrangement of antennas is possible dependently on the type and/or model of the UE 204 (e.g., a smartphone, a tablet, a wearable device, and/or a particular model of such devices).

The UE 204 can include a housing that defines user facing side (e.g., where a screen is located and is accessible to the user) and an opposing back side. The antennas (1)-(4) 210-240 can disposed within the housing near the back side, where the back side may include one or more radio frequency (RF) transparent windows at least at the antenna locations.

Each one of the antennas (1)-(4) 210-240 can be used for reception and/or transmission (e.g., can be a transmit and receive antenna). Further, one or more of the one of the antennas (1)-(4) 210-240 can include multiple antenna elements (e.g., can be an antenna panel that supports beamforming). The antennas (1)-(4) 210-240 can be components of an RF front end of the UE 204. This RF front end can support FDD and/or TDD technologies.

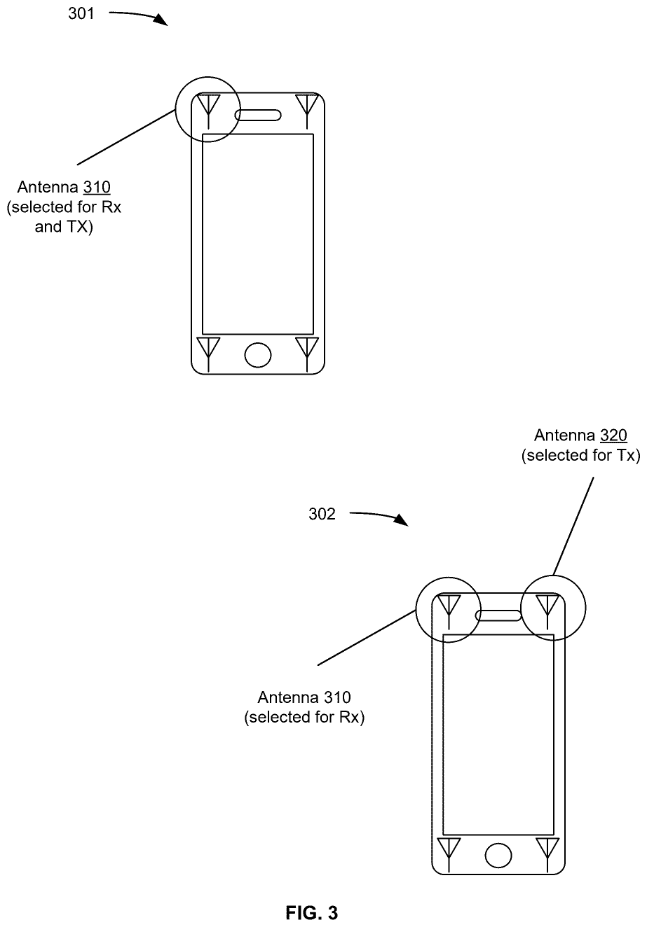

FIG. 3 illustrates examples of data reception and data transmission by a multi-antenna, in accordance with some embodiments. The UE is an example of the UE 204 of FIG. 2 and can include four antennas (although, as described in FIG. 2, the number and/or arrangement of antennas can be different). Two examples of data reception and data transmission are illustrated: a first example 301 shown in the top left corner of FIG. 3 and a second example 302 shown in the bottom right corner of FIG. 3.

In the first example 301, the same antenna 310 is selected for reception and transmission. This antenna 310 is illustrated as the top left corner antenna (e.g., the antenna (2) 220 of FIG. 2). A base station (e.g., the base station 108 of FIG. 1) can send a reference signal on a downlink channel. The different antennas can receive the downlink channel, thereby enabling reference signal measurements on the reference signal. Each of the reference signal measurements can correspond to one of the antennas. The reference signal measurements can be used to select the antenna 310 for the reception of subsequent downlink transmission from the base station. The antenna 310 can be the best suited antenna (e.g., provides the best antenna performance) for the reception given the AoA of the reference signal. In the first example 301, because the antenna 310 is selected for the reception, the antenna 310 is also selected for the transmission. This can be done so under the assumption that the antenna best suited for reception can also be best suited for transmission. As further described herein below, this assumption may not be always correct for different reasons (e.g, Inaccurate uplink path loss estimation due to separate frequency between the downlink and the uplink, inaccurate antenna efficiency model, antenna radiation pattern not accounted for, switching hysteresis threshold value that reduces the back and forth switching at the cost of potential performance loss, etc.).

In the second example 302, the antenna 310 is selected for reception. However, a different antenna 320 (e.g., the antenna (4) 240 of FIG. 2) is selected for transmission. This antenna selection does not use the above assumption and, therefore, can improve the antenna performance (e.g., improve the EIRP) that, in turn, can improve the UE performance (e.g., increase the data throughput at least on the uplink and/or reduce the power consumption). Instead, the antenna 320 can be selected based on a number of factors that collectively act as a proxy for the AoA. The factors can include, among other things, a user grip of the UE, the type of the UE, the frequency band, the duplexing technology (e.g. FDD or TDD), and the reference signal measurements. The antenna selection can be performed by the antenna selector 114 of FIG. 1 according to the techniques described in FIGS. 10-12.

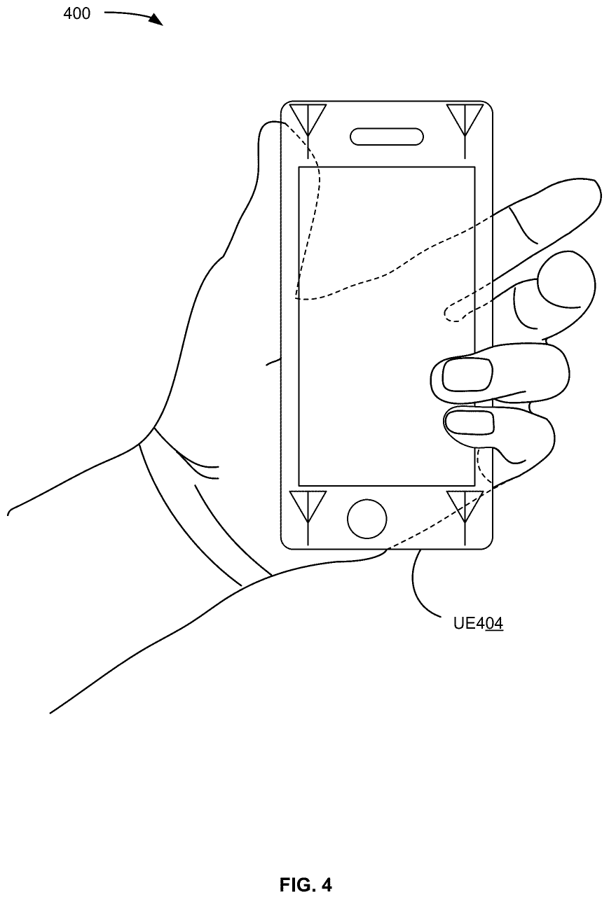

FIG. 4 illustrates an example 400 of a user grip of a multi-antenna UE 404, in accordance with some embodiments. The user grip can generally impact the signal path of an antenna used for transmission (e.g., by partially or fully blocking an RF transparent window of that antenna in the housing of the UE 404). As such, accounting for the user grip can improve at least the antenna's RF performance. FIG. 4 illustrates a portrait left hand grip (e.g., the UE 404 being held by a left hand of a user while being operated in a portrait mode). Other user grips are possible including, for example, no grip (e.g., the UE 404 being located on a table or some other surface and not being held by the user), a double-hands grip (e.g., the UE 404 being held by both hands of the user), a portrait right hand grip (e.g., the UE 404 being held by a right hand of the user while being operated in the portrait mode), a landscape left hand grip (e.g., the UE 404 being held by the left hand of the user while being operated in a landscape mode), and/or a landscape right hand grip (e.g., the UE 404 being held by the right hand of the user while being operated in the landscape mode).

As illustrated, the UE 404 is an example of the UE 204 of FIG. 2 and includes four antennas, each located at a corresponding corner of the UE 404. With the portrait left hand grip, the user's hand extends to the backside of the UE's 404 housing and their fingers can wrap around possibly covering a portion of the UE's 404 screen. Accordingly, the hand can cover (e.g., fully) the RF transparent window of the bottom left antenna (e.g., the antenna (3) 230 of FIG. 2). The hand and some of the fingers can also cover (e.g., at least partially) the RF transparent window of the bottom right antenna (e.g., the antenna (1) 210 of FIG. 2). The user's thumb may cover a portion of the RF transparent window of the top left antenna (e.g., the antenna (2) 220 of FIG. 2). The top right antenna (e.g., the antenna (4) 240 of FIG. 2) may not be covered by the user and, as such, may have a relatively better antenna performance for uplink transmissions.

However, considering only the user grip to select an antenna for the uplink transmission may not be sufficient. That is because of the directionally of the signal given the relative position of the UE 404 to the base station. In other words, the user grip cannot solely be a proxy for AoA. Instead, multiple approaches can be used.

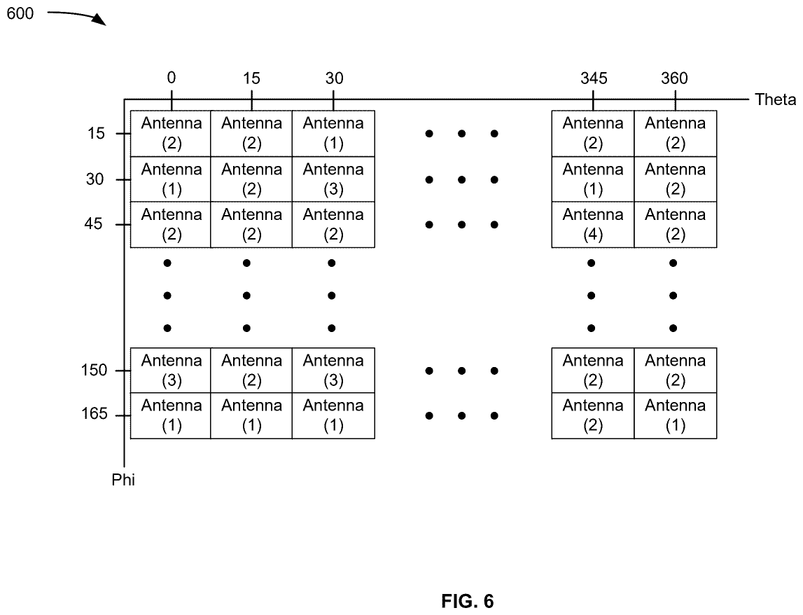

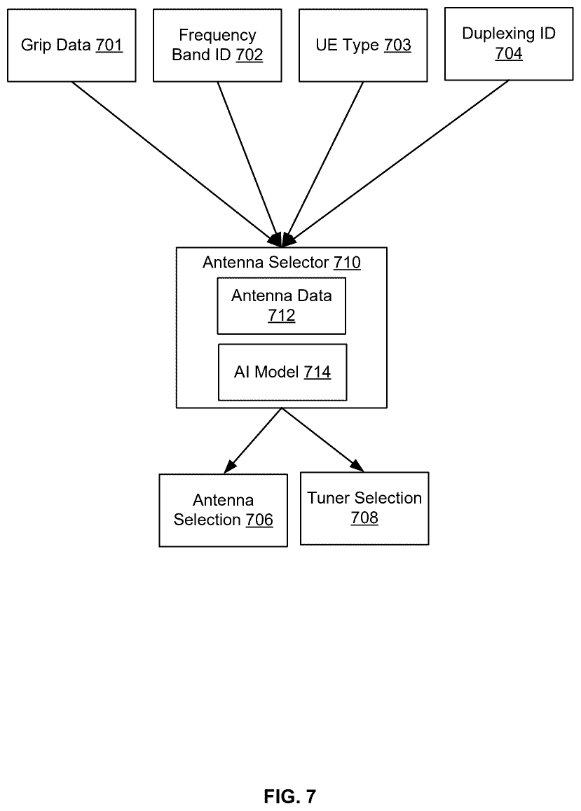

In a first approach, a simulation can be performed for the type and model of the UE 404 in a controlled environment. The simulation can include varying the AoA of received reference signals according to known values and determining the optimal antenna to use for an uplink transmission at each AoA. This can be done for each type of user grip and for different user grips (and, possibly, for different duplexing technologies). The simulation results can be processed to generate antenna data. The antenna data can associate, for the UE's type and model, an antenna subset with the user grip (and, possibly, the frequency band and the duplexing technology). The association indicates that antenna(s) belonging to the subset have the highest likelihood of providing the best antenna performance. This approach is further described in FIGS. 6 and 7.

In a second approach, instead of predefining the antenna data, an artificial intelligence (AI) model can be trained (e.g., an AI machine learning (ML) model). Once trained, input can be provided to the AI model. The input can include user grip data, reference signal measurements, an identifier of the frequency band, a type of the UE, and/or possibly a model of the UE and/or the duplexing technology. Based on this input, the AI model can generate an output. The output can indicate a selection of an antenna.

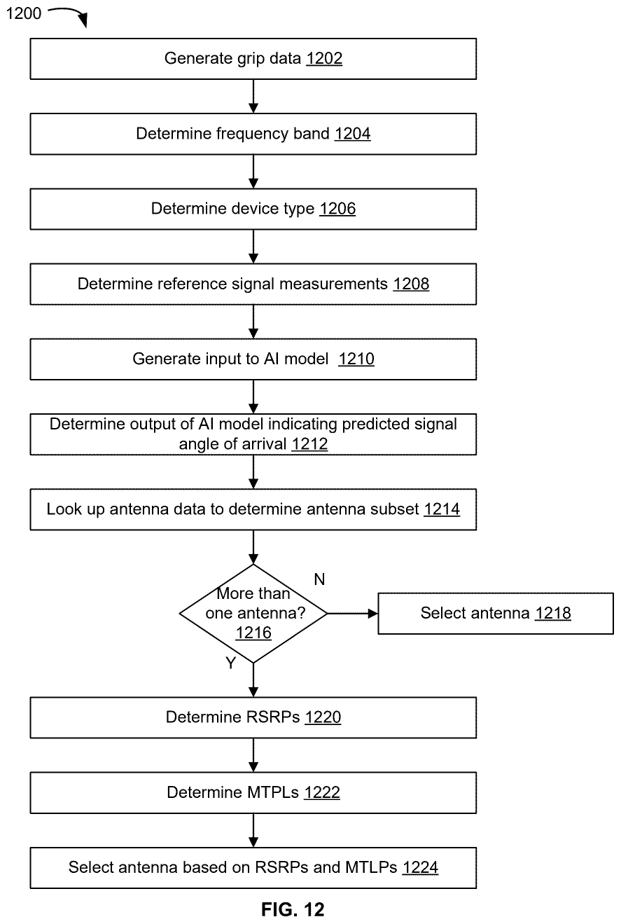

A third approach can be a hybrid approach. For example, the AI model can output a predicted signal AoA. The predicted AoA can be used to select the antenna based on a look up of antenna data. This approach is further described in FIG. 12.

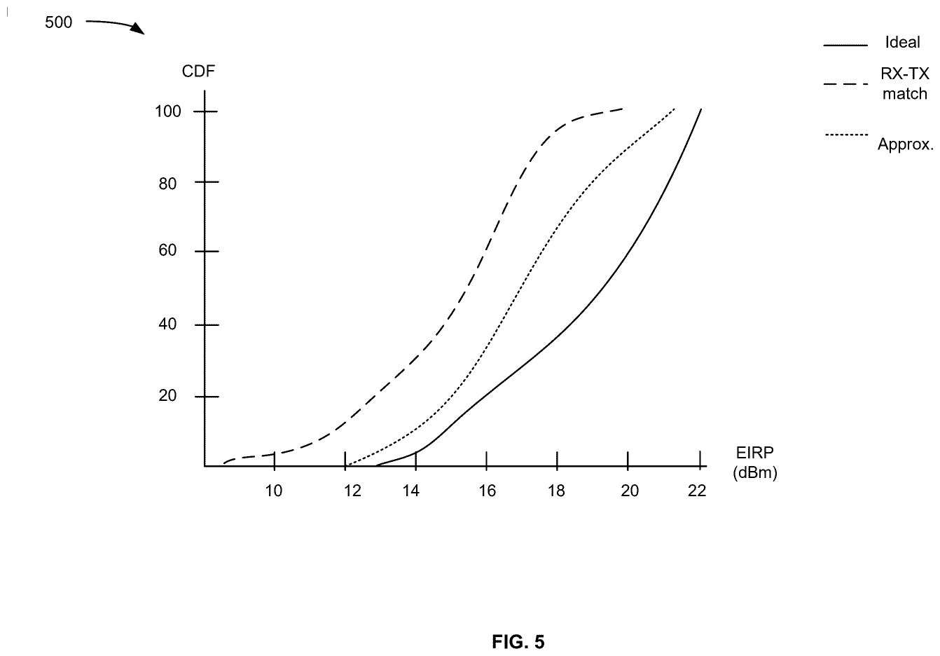

FIG. 5 illustrates an example of a plot 500 showing performances of different antenna selection techniques, in accordance with some embodiments. The horizonal line shows values for EIRP in dBm as an example of an antenna performance. The vertical line shows values for a cumulative distribution function (CDF).

Three techniques are simulated. The first technique corresponds to an ideal technique (shown with a solid line), where an antenna is selected knowing an AoA value. The second technique corresponds to the example 301 (shown with a dashed line), where the antenna selection for transmission matches the antenna used for reception. The third technique corresponds to the example 302 (shown with a dotted line), where the antenna selection for transmission need not match the antenna used for reception. The CDF values of each technique can be generated, via simulations at different EIRP values, from likelihoods that the selected antenna is the optimal antenna across different AoAs. The simulation involves a UE similar to the UE 204 of FIG. 2, that includes four antennas distributed at four corners of the UE.

As illustrated, the first technique provides the best antenna performance, whereas the second technique provides the worst antenna performance among the three techniques. The third technique provides improvements (e.g., between 1 and 3 dB) relative to the second technique. As such, when the AoAs are not known, the third technique can represent an improvement over the second technique. These improvements can be significant when the FDD technology is used. That is because, in FDD, the frequency separation between the downlink band and the uplink band can be large (e.g., 400 MHz) and, thus, the assumption that the second technique can become incorrect. In TDD, the improvements can still be significant due to many factors, such as the antenna efficiency and/or antenna switching.

FIG. 6 illustrates an example 600 of antenna selections across different signal AoAs, in accordance with some embodiments. The example 600 corresponds to a simulation of the antenna selections for a particular UE (e.g., a four-antenna smartphone of a certain model), given a particular frequency band (e.g., frequency band n4), a particular user grip (e.g., landscape left hand grip), and duplexing technology (e.g., FDD or TDD). Each signal AoA corresponds to a simulated (and, thus, known) AoA of a reference signal received by the UE and is shown in a spherical coordinate system (e.g., Phi “φ” on the vertical axis and Theta “θ” on the horizontal axis).

Consider “Phi=0” and “Theta=15.” As illustrated, antenna (2) (e.g., the top left corner antenna (2) 220 of FIG. 2) is the best performing antenna at that AoA. Accordingly, antenna (2) would be selected for uplink transmission. Any other antenna selection would result in a lower performance at the “Phi=0” and “Theta=15” AoA. In contrast, consider “Phi=360” and “Theta=165.” Here, antenna (1) (e.g., the bottom right corner antenna (1) 210 of FIG. 2) is the best performing antenna at that AoA. Accordingly, antenna (1) would be selected for uplink transmission. Any other antenna selection would result in a lower performance at the “Phi=360” and “Theta=165” AoA.

The example 600 represents a heatmap of antenna selections across the signal AoAs. From the heat map, antenna selections and a CDF can be derived. In particular, the total number of antenna selections is “K” (which is the total number of AoAs). The total number an antenna “i” is selected is “Nᵢ.” When an antenna “i” is selected (and the AoA is unknown), the likelihood of this antenna being the best performing antenna is “Nᵢ/K.” Say, in the example 600, “K” is equal to two-hundred sixty-four. And say that antenna (2) is selected one-hundred eighty-nine times across the AoAs. In this case, when the antenna (2) is selected, the likelihood of this antenna being the best performing antenna is equal to “189/264=70%.”

An antenna subset can include “j” antennas out of the plurality of antennas (e.g., “1≤j<4”). When this subset is selected (and the AoA is unknown), the likelihood of the antenna subset including an antenna that is the best performing antenna is

$${}^{″} {\sum }_{i = 1}^{j} Ni / K {.}^{″}$$

Say that the subset includes, in addition to antenna (2), antenna (1) and an antenna (1) is selected twenty-five times. In this case, when the subset is selected, the likelihood of one of its two antennas being the best performing antenna is equal to “189/264+25/264-80%.”

The CDF can be generated by varying the different factors including the UE type, the frequency band, the multiplexing technology, and/or the user grip. Particularly, the corresponding antenna selections can be simulated for the different signal AoAs given a particular value set for these factors. The corresponding antenna selection likelihoods can be computed. The simulations and computations can be repeated for the different values sets of the factors, resulting in the CDF.

Antenna data can also be derived based on the example 600 (and similar simulations). For example, the antenna data can associate the likelihood of a selected antenna “i” being the best performing antenna with the different factors (e.g., the UE type, the frequency band, the multiplexing technology, and/or the user grip). This association can be organized using a data structure. A look-up table (LUT) is one example of the data structure, although other examples are possible, such as a string, an array, a database, etc. For example, different factors can be used as a key in a key-value pair, and the specific likelihood per antenna or antenna subset can be a value in the key-value pair. Such a LUT can store many entries, one for each possible variation of the factors. An example LUT with two rows is shown below for illustrative purposes, although a more extensive LUT can be used. The first row corresponds to a landscape left hand grip, whereas the second row corresponds to a portrait right hand grip.

TABLE 1

| | Frequency | | | | Antenna |
|---|---|---|---|---|---|
| User Grip | Band | Device Type | Duplexing | Antenna | Subset |
| Landscape | n4 | Smartphone | FDD | Antenna | Antennas |
| left hand | | XYZ | | (2) | (1)-(2) |
| grip | | | | 70% | 80% |
| Portrait | n4 | Smartphone | FDD | Antenna | Antennas |
| right hand | | XYZ | | (1) | (1) and (3) |
| grip | | | | 65% | 88% |

In the above Table 1, if a “Smartphone XYZ” UE is to transmit over the frequency band n4 using FDD technology, while being held by a left hand of a user and operated in a landscape mode, antenna (2) has a 70% likelihood of being the best performing antenna, whereas antenna subset formed by antennas (1) and (2) has an 80% likelihood of including the best performing antenna. Depending on a predefined threshold, either the antenna (2) is selected or the subset of antennas (1) and (2) is selected for further processor to select one of the two antennas. For instance, if the threshold is set to 60%, antenna (2) is selected. If the threshold is set to 75%, the subset is selected. Of course, Table 1 is only an illustrative example of the LUT.

Additional or alternate data can be included in the LUT (e.g., the likelihood of each antenna, the recommended antenna selection without any likelihood values, etc.).

FIG. 7 illustrates an example of an antenna selection 706, in accordance with some embodiments. The antenna selection 706 can be performed by an antenna selector 710 of a UE, such as the UE 202 of FIG. 2. The antenna selector 710 can select a particular antenna from a plurality of antennas of the UE based on an input. Based on the inputs, the antenna selector 710 generates an output. The output corresponds to the antenna selection 706 and can include an identifier of the selected antenna.

The selection can rely on antenna data 712, such as the one described in FIG. 6. In particular, the input can be used in a look-up of the antenna data 712. The antenna data 712 can indicate an antenna to select (or the antenna subset from which the antenna is selected) based on the input. The antenna data 712 can include an entry generated from simulations, where the simulations indicate that this antenna (or the antenna subset subset) has the highest likelihood of providing the best antenna performance (e.g., EIRP) or of being selected from the plurality of antennas (or different antenna subsets) under certain factors quantified in the input. The antenna data 712 itself may include the likelihood or may simply indicate that the antenna is to be selected (or the antenna subset is to be selected) without including the corresponding likelihood. An example selection that relies on the antenna data 712 is illustrated in FIG. 10.

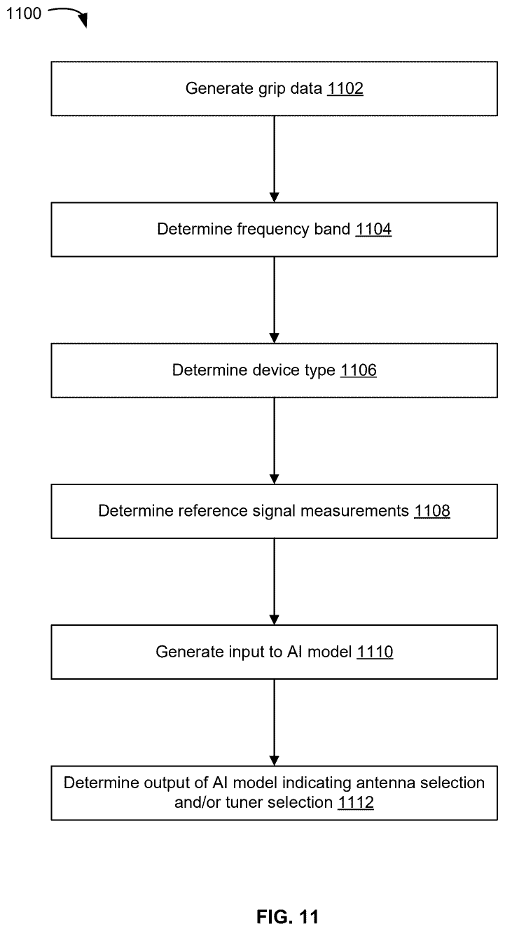

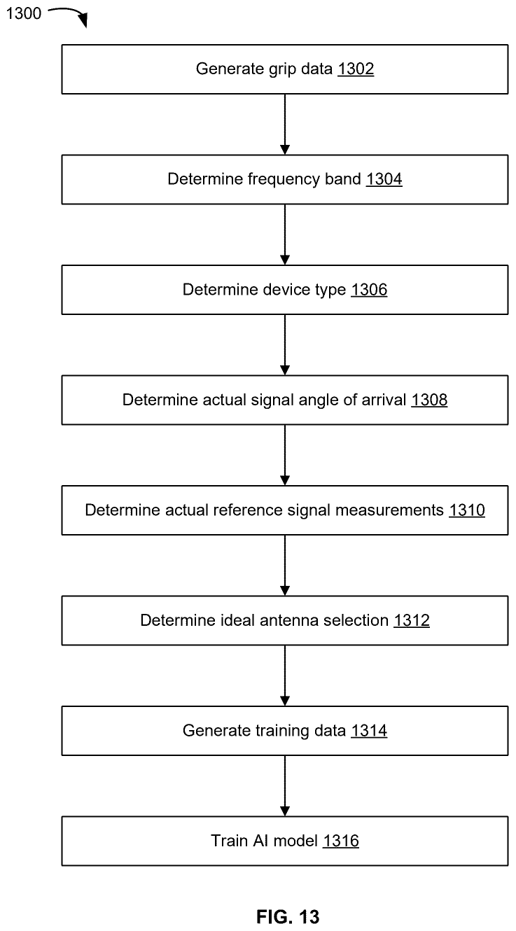

Alternatively, or additionally, the selection can rely on an AI model 714. In particular, the input is provided to the AI model 714 that outputs the antenna selection 706. The AI model can be trained on historical inputs to generated antenna selections. An example selection that involves the AI model 714 is illustrated in FIG. 11 and the related AI training is illustrated in FIG. 13.

A combination of using the antenna data 712 and the AI model 714 is possible. In particular, the input is provided to the AI model 714 that outputs a predicted AoA. The data structure can include entries corresponding to the example 600. These entries can then be looked up given the predicted AoA to determine the antenna to be selected. An example selection that involves the antenna data 712 and the AI model 714 is illustrated in FIG. 12.

The input can include any or a combination of grip data 701, a frequency band identifier (ID) 702, a UE type 703, and/or a duplexing ID 704. The grip data 701 and identify the type of the user grip and can be generated as further described in FIGS. 8-9. The frequency band ID 702 can indicate the frequency band that is to be used for uplink transmissions. The UE type 703 can include an identifier of the type and/or model of the UE. The duplexing ID 704 can indicate whether FDD and/or TDD are to be used for the uplink transmissions.

The antenna selector 710 can be further or alternatively configured to output a tuner selection 708. Generally, an antenna (e.g., a reception antenna used for downlink reception) can be associated with multiple antenna tuner states. Each tuner state corresponds to a set of parameters that control the downlink reception. The set of parameters can include, by way of illustration, an impedance, resonance, etc. Based on one or more of the above inputs (e.g., the grip data 701, the frequency band ID 702, the UE type 703, and/or the duplexing ID 704), the antenna selector 710 (e.g., by using the antenna data 712 and/or the AI model 714) can select one or more of the antenna tuner states and outputs this selection as the tuner selection 708. The tuner selectin 708 can be used by an antenna controller to control the downlink reception according to the corresponding parameters.

FIG. 8 illustrates an example of an operational flow/algorithmic structure 800 implemented by a UE (or an apparatus of the UE, where the apparatus includes processing circuitry) to determine a user grip, in accordance with some embodiments. The UE can be any of the UEs described herein. In some embodiments, the operational flow/algorithmic structure 800 may be implemented by executing instructions stored in a tangible, non-transitory, computer-readable storage medium, such as a memory of the UE. While the operational flow/algorithmic structure 800 is described using steps in a specific sequence, it should be understood that the present disclosure contemplates that the described steps may be performed in different sequences than the sequence illustrated, and certain described steps may be omitted or not performed altogether.

In an example, the operational flow/algorithmic structure 800 includes, at 802, determining whether the UE is being held next to a user's head (against their ear) or not. For instance, if a peripheral device is connected to the UE (e.g., a headphone or some other earpiece) and is outputting application data (e.g., incoming audio data of a phone call), the determination is that the UE is being held next to the user's head. Other data can be used including for example, acceleration data and gyroscope data of sensors of the UE. For example, if audio is coming out of an earpiece, the determination is that the UE is being held next to the user's head. Otherwise, the determination is that the UE is not being held next to the user's head. If held next to the user's head, operation 804 can follow operation 802. Otherwise, operation 810 can be followed.

In an example, the operational flow/algorithmic structure 800 includes, at 804, determining whether the hand holding the UE is known or not (e.g., whether the UE is held by the left hand or the right hand of the user). There can be situations where the type of the hand holding is unknown. In this case, operation 806 follows operation 804, where a determination is made that the UE is being held against the head using the left hand or the right hand. Otherwise, operation 820 can be followed. Different techniques can be used to derive the type of the hand holding to the head and can rely on sensor data generated by sensors of the UE. Such sensor data can include gyroscope and/or accelerator data. Reference signals can also be used to determine the type of hand holding, as further described herein below.

In an example, the operational flow/algorithmic structure 800 includes, at 810, determining whether motion is detected (e.g., the UE is being or was moved between two positions). Here, the acceleration data and/or the gyroscope data can be used. If in motion, operation 820 follows operation 810. Otherwise, operation 812 can be followed, where a determination of a non-grip is made.

In an example, the operational flow/algorithmic structure 800 includes, at 820, determining whether the UE is being operated in a portrait mode or not. For instance, the operating system of the UE can output an indication of the landscape mode or a portrait mode. Additionally, or alternatively, an application data executing on the device and generating application data to be transmitted can output such an indication. If being operated in the portrait mode, operation 830 follows operation 820. Otherwise, operation 850 can be followed.

In an example, the operational flow/algorithmic structure 800 includes, at 830, performing a portrait reference signal (RSRP, RSSI, SINR, or SNR) based grip detection to determine whether the portrait grip is a left grip, right grip, or is a no-grip. Here, a reference signal can be received via antennas of the UE from a base station. RSRP, RSSI, SINR, and/or SNR measurements can be performed given each reference signal reception, resulting in at least one reference signal measurement per antenna. The reference signal measurements of the different antennas can be compared to then determine the type of the grip. For example, each possible user grip can be associated with an RSRP range of per antenna. For a candidate grip, the RSRP measurements can be compared to the corresponding RSRP ranges. If a match is found (e.g., for each antenna, the corresponding RSRP measurement is within the RSRP range of the antenna), the candidate grip can be declared as the grip.

To illustrate and referring to FIG. 4 that shows the portrait left hand grip, the bottom left antenna is expected to have the lowest RSRP measurement, whereas the top right antenna is expected to have the best RSRP measurement. The bottom right antenna's RSRP measurement is supposed to be better than the bottom left antenna's RSRP measurement but worse than the top left antenna's RSRP measurement. Four RSRP ranges can be defined: the best range being for the top right antenna, followed by that of the top left antenna, then the bottom right antenna, and finally the bottom left antenna. When the RSRP measurements of the four antennas are found to fall in these ranges, then this grip is declared (e.g., which can be the case when the bottom right antenna's RSRP measurement is better than the bottom left antenna's RSRP measurement but worse than the top left antenna's RSRP measurement that, in turn, is worse than the trop right antenna's RSRP measurement).

Operation 832 can follow operation 830 if no match is found, whereby an unknown grip is determined. Similarly, the unknown grip is determined if operation 832 follows operation 850 as discussed below. If a match is found for a grip, operation 840 can follow operation 830, where a portrait left hand grip or a portrait right hand grip is determined.

In an example, the operational flow/algorithmic structure 800 includes, at 850, performing a landscape reference signal based grip detection to determine whether the landscape grip is a left grip, right grip, or is a no-grip. Operation 850 is similar to operation 830. Here, the RSRP ranges are defined for the landscape mode for example. Operation 832 can follow operation 850 if no match is found. If a match is found for a grip, operation 852 can follow operation 850, where a landscape left hand grip or a landscape right hand grip is determined.

For each operation 806, 812, 832, 840, and 852, corresponding tuner settings are applied for best reception and best antennas are selected for transmission.

FIG. 9 illustrates another example of an operational flow/algorithmic structure 900 implemented by a UE (or an apparatus of the UE, where the apparatus includes processing circuitry) to determine a user grip, in accordance with some embodiments. The UE can be any of the UEs described herein. In some embodiments, the operational flow/algorithmic structure 900 may be implemented by executing instructions stored in a tangible, non-transitory, computer-readable storage medium, such as a memory of the UE. While the operational flow/algorithmic structure 900 is described using steps in a specific sequence, it should be understood that the present disclosure contemplates that the described steps may be performed in different sequences than the sequence illustrated, and certain described steps may be omitted or not performed altogether.

Generally, the flow/algorithmic structure 900 involves the use of an (AI) model, such as a machine learning (ML) model (e.g., an artificial neural network). The AI model is pre-trained to predict user grip. An example input to the AI model includes an interference between a transmit antenna and a receive antenna of the UE. This interference can be referred as self-interference or signal coupling between the transmit antenna and a receive antenna. Self-interference is one example of inputs to the AI model. Other inputs (e.g., RSRP measurements, signal-to-interference-plus-noise ratio (SINR) measurements, etc.) can additionally or alternatively be used.

In an example, the operational flow/algorithmic structure 900 includes, at 902, generating self-interference measurements corresponding to antennas for the UE. An antenna can be used for transmission and for reception (doing so occurs at different times in TDD and FDD use cases). Additionally, or alternatively, an antenna can be used for transmission (referred to as transmit antenna) and a different antenna can be used for reception (referred as a receive antenna). In this case, the reception and transmission can occur at the same time and can use TDD or FDD technologies. Self-interference can occur, whereby the transmission using the transmit antenna interferes with the reception using the receive antenna. Different techniques can exist for measuring the self-interference. Some of these techniques can be performed online (e.g., while the UE is being used). For example, a feedback mechanism can be included in the UE's RF front end to adjust a transmit power. Measurements can be made with and without the feedback mechanism being enabled, allowing to determine a performance improvement to the received signal. This performance improvement can be correlated to the self-interference. Particularly, a first measurement can be performed on a received signal by a receive antenna (e.g., a first RSRP measurement), while the transmit power of a transmit antenna is not adjusted (e.g., while feedback mechanism is disabled). Next, the feedback mechanism is enabled and the transmit power is adjusted (e.g., increased). The received signal is measured again (e.g., a second RSRP measurement). The difference between the two measurements (e.g., the RSRP difference) and the transmit power adjustment can indicate the self-interference. To illustrate, assume that the transmit power was increased by 3 dB and the RSRP difference is 2 dB, the self-interference can be measured to be about 1 dB.

In an example, the operational flow/algorithmic structure 900 includes, at 904, generating an input to the AI model based on the self-interference measurements. For example, the input can include the self-interference measurements and can identify, for each self-interference measurement, the corresponding pair of transmit and receive antennas.

In an example, the operational flow/algorithmic structure 900 includes, at 906, determining an output of the AI model based on the input, the output indicating a user grip. For instance, the output includes a prediction of whether the UE is in a non-grip position or is being held with both hands, the left hand, or the right hand. The operating system and/or an application on the UE can indicate whether the UE is operated in a landscape mode or a portrait mode. This indication can be coupled with the prediction to increase its granularity to the landscape and/or portrait mode. Alternatively, the prediction can also include this level of granularity.

In an example, multiple handgrip states can be predefined, each corresponding to a candidate user grip. For instance, the user grip states can correspond to a non-grip, a double-hands grip, a landscape grip (possibly a left-hand landscape grip or a landscape right-hand grip), or a portrait grip (possibly a left-hand portrait grip or a right-hand portrait grip). The above operational flow/algorithmic structure 900 can be implemented to select a handgrip from the predefined handgrips and this selection can be used at least in part to control the antenna use for transmission and/or reception. Particularly, reference signal measurements can be determined. Each reference signal measurement corresponds to one of a plurality of antennas of a UE. An input to an artificial intelligence model can be generated based on the reference signal measurements. An output of the artificial intelligence model can be determined based on this input, where the output indicates at least one of the handgrip states. Based on the output, a handgrip state is selected (e.g., one of the indicated states). Based on the selected handgrip state, an antenna for uplink transmission of the plurality of antennas can be selected and/or a tuner state can be selected.

The AI model can be trained in an offline manner. For example, training data can be generated using simulations or actual controlled measurements (that can rely on different UEs and UE types) across the possible user grips. For a user grip, the training data can include, per antenna pair, a value of a corresponding self-interference and a label that identifies the user grip. The self-interference values of the different antenna pairs with the identifiers of these pairs can be input to the AI model that predicts a user grip. The predicted user grip can be compared to the label. If the comparison results in a match, a reward is computed (e.g., according to a reward function). Otherwise, a penalty is computed (e.g., according to a penalty function). The parameters of the AI model (e.g., weights of connections between nodes of different layers of the AI model) can be updated based on the penalty and/or reward (e.g., by using a backpropagation algorithm). The training can be iteratively repeated by using different self-interference values and/or user grips.

FIG. 10 illustrates an example of an operational flow/algorithmic structure 1000 implemented by a UE (or an apparatus of the UE, where the apparatus includes processing circuitry) to select an antenna and/or a tuner state, in accordance with some embodiments. The UE can be any of the UEs described herein. In some embodiments, the operational flow/algorithmic structure 1000 may be implemented by executing instructions stored in a tangible, non-transitory, computer-readable storage medium, such as a memory of the UE. While the operational flow/algorithmic structure 1000 is described using steps in a specific sequence, it should be understood that the present disclosure contemplates that the described steps may be performed in different sequences than the sequence illustrated, and certain described steps may be omitted or not performed altogether.

In an example, the operational flow/algorithmic structure 1000 includes, at 1002, generating grip data. The grip data can indicate a user grip of the UE and can be generated using the techniques described in FIG. 8 or 9.

In an example, the operational flow/algorithmic structure 1000 includes, at 1004, determining a frequency band for an uplink transmission to a base station. For instance, DCI or RRC signaling is received from the base station and is processed. The processing can identify the frequency band to use.

In an example, the operational flow/algorithmic structure 1000 includes, at 1006, determining a device type of the UE. For instance, the device type is indicated by an operating system or system settings of the UE.

In an example, the operational flow/algorithmic structure 1000 includes, at 1008, looking up antenna data to determine an antenna subset of the UE's antennas and/or one or more tuner states. For instance, the look-up uses any or a combination of the grip data, the frequency band identifier, and/or the device type. Other data can also be used in the look-up, such as whether the uplink transmission is to use FDD or TDD technology (which can be determined from the RRC signaling or be pre-associated with the frequency band). The look-up can return, from the antenna data, a result indicating that selecting the antenna subset has the highest likelihood of including the best performing antenna for uplink transmission and/or that selecting a tuner stage has the highest likelihood of best downlink reception performance.

In an example, the operational flow/algorithmic structure 1000 includes, at 1010, determining whether the antenna subset indicates that more than one antenna can be selected. For instance, if the subset includes more than one antenna identifier, operation 1020 can follow operation 1010. Otherwise, operation 1012 can be followed.

In an example, the operational flow/algorithmic structure 1000 includes, at 1012, selecting an antenna based on the antenna subset. Here, the antenna subset includes one antenna identifier. The antenna corresponding to this identifier is selected for the uplink transmission. Operations 1010 and 1012 can be similarly performed when the look-up results in a single tuner state.

In an example, the operational flow/algorithmic structure 1000 includes, at 1020, determining reference signal measurements (e.g., RSRP, RSSI, SINR, and/or SNR) corresponding to the antenna subset. Here, the antenna subset includes multiple antenna identifiers. The reference signal of each antenna identified by the antenna subset is retrieved from memory or is generated based on reception of a reference signal by the antenna.

In an example, the operational flow/algorithmic structure 1000 includes, at 1022, determining maximum transmit power levels (MTPLs) corresponding to the antenna subset. Her also, the MTPL of each antenna identified by the antenna subset is retrieved from memory.

In an example, the operational flow/algorithmic structure 1000 includes, at 1024, selecting an antenna identified in the antenna subset based on the reference signal measurements and the MTPL. For instance, differences between the reference signal measurements of antennas and differences between MTPLs of antennas are compared and the result of the comparison can drive the selection. To illustrate, assume that the antenna subset indicates a first antenna and a second antenna. A first RSRP and a first MTPL are determined for the first antenna. A second RSRP and a second MTPL are determined for the second antenna. A first difference between the second RSRP and the first RSRP is computed. A second difference between the first MTPL and the second MTPL is computed. If the first difference is greater than the second difference, the second antenna is selected, otherwise, the first antenna is selected. Operations 1020-1024 can be similarly performed when the look-up results in multiple tuner states.

FIG. 11 illustrates another example of an operational flow/algorithmic structure 1100 implemented by a UE (or an apparatus of the UE, where the apparatus includes processing circuitry) to select an antenna and/or a tuner state, in accordance with some embodiments. The UE can be any of the UEs described herein. In some embodiments, the operational flow/algorithmic structure 1100 may be implemented by executing instructions stored in a tangible, non-transitory, computer-readable storage medium, such as a memory of the UE. While the operational flow/algorithmic structure 1100 is described using steps in a specific sequence, it should be understood that the present disclosure contemplates that the described steps may be performed in different sequences than the sequence illustrated, and certain described steps may be omitted or not performed altogether.

In an example, the operational flow/algorithmic structure 1100 includes, at 1102, generating grip data. The grip data can indicate a user grip of the UE and can be generated using the techniques described in FIG. 8 or 9.

In an example, the operational flow/algorithmic structure 1100 includes, at 1104, determining a frequency band for an uplink transmission to a base station. For instance, DCI or RRC signaling is received from the base station and is processed. The processing can identify the frequency band to use.

In an example, the operational flow/algorithmic structure 1100 includes, at 1106, determining a device type of the UE. For instance, the device type is indicated by an operating system or system settings of the UE.

In an example, the operational flow/algorithmic structure 1100 includes, at 1108, determining reference signal measurements (e.g., RSRP, RSSI, SINR, and/or SNR). For instance, the base station transmits a reference signal. This reference signal is received by antennas of the UE. The reception of the reference signal by antenna can be processed to generate an RSRP, RSSI, SINR, and/or RSRP measurement(s) corresponding to the antenna. The RSSI, SINR, and/or RSRP measurement(s) can be associated with the identifier of the antenna.

In an example, the operational flow/algorithmic structure 1100 includes, at 1110, generating an input to an AI model. This input can be generated based on the reference signal measurements and, optionally, based on any or a combination of the grip data, the frequency band, or the device type. For instance, the input can include the reference signal measurements and the corresponding antenna identifiers. Additionally, the input can include grip data, the identifier of the frequency band, and/or the device type. Other inputs are additionally or alternatively possible, such as an indication of whether FDD or TDD is to be used for the uplink transmission.

In an example, the operational flow/algorithmic structure 1100 includes, at 1112, determining an output of the AI model, the output indicating an antenna selection and/or a tuner selection. For instance, the AI model generates the output in response to the input. The output includes an identifier of the antenna. This antenna is selected for the uplink transmission. Similarly, or alternatively, the output can indicate an identifier of a tuner state. The tuner state is selected for the downlink transmission.

FIG. 12 illustrates yet another example of an operational flow/algorithmic structure 1200 implemented by a UE (or an apparatus of the UE, where the apparatus includes processing circuitry) to select an antenna, in accordance with some embodiments. The UE can be any of the UEs described herein. In some embodiments, the operational flow/algorithmic structure 1200 may be implemented by executing instructions stored in a tangible, non-transitory, computer-readable storage medium, such as a memory of the UE. While the operational flow/algorithmic structure 1200 is described using steps in a specific sequence, it should be understood that the present disclosure contemplates that the described steps may be performed in different sequences than the sequence illustrated, and certain described steps may be omitted or not performed altogether.

In an example, the operational flow/algorithmic structure 1200 includes, at 1202, generating grip data. The grip data can indicate a user grip of the UE and can be generated using the techniques described in FIG. 8 or 9.

In an example, the operational flow/algorithmic structure 1200 includes, at 1204, determining a frequency band for an uplink transmission to a base station. For instance, DCI or RRC signaling is received from the base station and is processed. The processing can identify the frequency band to use.

In an example, the operational flow/algorithmic structure 1200 includes, at 1206, determining a device type of the UE. For instance, the device type is indicated by an operating system or system settings of the UE.

In an example, the operational flow/algorithmic structure 1200 includes, at 1208, determining RSRP measurements. For instance, the base station transmits a reference signal. This reference signal is received by antennas of the UE. The reception of the reference signal by antenna can be processed to generate a reference signal measurement corresponding to the antenna. This measurement can be associated with the identifier of the antenna.

In an example, the operational flow/algorithmic structure 1200 includes, at 1210, generating an input to an AI model. This input can be generated based on the reference signal measurements and, optionally, based on any or a combination of the grip data, the frequency band, or the device type. For instance, the input can include the RSRP measurements and the corresponding antenna identifiers. Additionally, the input can include grip data, the identifier of the frequency band, and/or the device type. Other inputs are additionally or alternatively possible, such as an indication of whether FDD or TDD is to be used for the uplink transmission.

In an example, the operational flow/algorithmic structure 1200 includes, at 1212, determining an output of the AI model, the output indicating a predicted signal AoA. For instance, the AI model generates the output in response to the input. The output includes a value for this AoA.

In an example, the operational flow/algorithmic structure 1200 includes, at 1214, looking up antenna data to determine an antenna subset of the UE's antennas. For instance, the look-up includes the predicted AoA. It is possible that the look-up also includes the input used for the AI model. The look-up can return, from the antenna data, a result indicating that selecting the antenna subset has the highest likelihood of including the best performing antenna.

In an example, the operational flow/algorithmic structure 1200 includes, at 1216, determining whether the antenna subset indicates that more than one antenna can be selected. For instance, if the subset includes more than one antenna identifier, operation 1220 can follow operation 1216. Otherwise, operation 1218 can be followed.

In an example, the operational flow/algorithmic structure 1200 includes, at 1218, selecting an antenna based on the antenna subset. Here, the antenna subset includes one antenna identifier. The antenna corresponding to this identifier is selected for the uplink transmission.

In an example, the operational flow/algorithmic structure 1200 includes, at 1220, determining RSRPs corresponding to the antenna subset. Here, the antenna subset includes multiple antenna identifiers. The RSRP of each antenna identified by the antenna subset is retrieved from memory or is generated based on reception of a reference signal by the antenna.

In an example, the operational flow/algorithmic structure 1200 includes, at 1222, determining maximum transmit power levels (MTPL) corresponding to the antenna subset. Her also, the MTPL of each antenna identified by the antenna subset is retrieved from memory.

In an example, the operational flow/algorithmic structure 1200 includes, at 1224, selecting an antenna identified in the antenna subset based on the RSRPs and the MTPLs. For instance, differences between the RSRPs of antennas and differences between MTPLs of antennas are compared and the result of the comparison can drive the selection. To illustrate, assume that the antenna subset indicates a first antenna and a second antenna. A first RSRP and a first MTPL are determined for the first antenna. A second RSRP and a second MTPL are determined for the second antenna. A first difference between the second RSRP and the first RSRP is computed. A second difference between the first MTPL and the second MTPL is computed. If the first difference is greater than the second difference, the second antenna is selected, otherwise, the first antenna is selected.

FIG. 13 illustrates an example of an operational flow/algorithmic structure for 1300 training an artificial intelligence (AI) model for antenna selection and/or tuner selection, in accordance with some embodiments. The training can be performed on a computer system (e.g., a set of servers). In some embodiments, the operational flow/algorithmic structure 1300 may be implemented by executing instructions stored in a tangible, non-transitory, computer-readable storage medium, such as a memory of the computer system. While the operational flow/algorithmic structure 1300 is described using steps in a specific sequence, it should be understood that the present disclosure contemplates that the described steps may be performed in different sequences than the sequence illustrated, and certain described steps may be omitted or not performed altogether. Upon completion of the training (or completion of any further training using similar operations), the AI model can be sent (e.g., as program code or an update thereto) to a UE.

In an example, the operational flow/algorithmic structure 1300 includes, at 1302, generating grip data. Here, the grip data can be generated using actual testing of a UE in a controlled environment or via a simulation. The testing or simulation can span multiple user grips. Each user grip is documented.

In an example, the operational flow/algorithmic structure 1300 includes, at 1304, determining a frequency band. Here, the testing or simulation can span multiple frequency bands. Each frequency band is documented.

In an example, the operational flow/algorithmic structure 1300 includes, at 1306, determining a device type. Here, the testing or simulation can span multiple device types. Each device type is documented. Other testing or simulation parameters can also be used and documented such as the duplexing technology.

In an example, the operational flow/algorithmic structure 1300 includes, at 1308, determining an actual signal AoA. Given a user grip, a frequency band, and a UE having a device type (and possibly other testing or simulation parameters), an AoA of a reference signal is measured via testing or is simulated and is documented. These parameters form one parameter set. Any of the testing or simulation parameters (e.g., user grip, device type, frequency band, type of reference signal) can be varied, resulting in a different parameter set and a different signal AoA. The different AoAs can be documented, whereby the documentation associates each AoA with the corresponding parameter set.

In an example, the operational flow/algorithmic structure 1300 includes, at 1310, determining actual reference signal measurements. Similarly, given a parameter set, a reference signal measurement per antenna reception of the reference signal is measured via testing or is simulated and is documented. Because multiple antennas exist, multiple reference signal measurements are generated and are associated, as a group of reference signal measurements, with the same parameter set. Any of the testing or simulation parameters (e.g., user grip, device type, frequency band, type of reference signal) can be varied, resulting in a different parameter set and a different group of reference signal measurements. The reference signal measurements can be documented, whereby the documentation associates each reference signal measurement group with the corresponding parameter set and the corresponding AoA.

In an example, the operational flow/algorithmic structure 1300 includes, at 1312, determine an ideal antenna selection and/or an ideal tuner state selection. For instance, the testing or simulation can indicate which antenna of the multiple antennas provides the best antenna performance for uplink transmission and which tuner state provides the best antenna performance for downlink transmission given an AoA and a corresponding parameter set. This antenna is the ideal antenna. This tuner state is the ideal tuner state Each AoA and corresponding parameter set can be associated with an ideal antenna and/or an ideal tuner state. The identifiers of the ideal antennas and ideal tuner states can be documented, whereby the documentation associates each ideal antenna identifier and/or ideal tuner state with the corresponding AoA, parameter set, and group of RSRP measurements.

In an example, the operational flow/algorithmic structure 1300 includes, at 1314, generating training data. Different types of data can be included in the training data depending on the desired output of the AI model.

In one example, the AI model is trained to predict antenna selections and/or tuner states. Here, the training data includes the identifiers of the ideal antennas and/or of the tuner states as labels (e.g., ground truth for the training) and the reference signal measurement groups as variables. Optionally, the AoAs and parameter sets are also included.

In another example, the AI model is trained to predict AoAs. Here, the training data includes the documented AoAs as labels (e.g., ground truth for the training) and the reference signal measurement groups as variables. Optionally, the parameter sets are also included.

In an example, the operational flow/algorithmic structure 1300 includes, at 1316, training the AI model based on the training data. Different types of training can be performed depending on the desired output of the AI model.

In one example, the AI model is trained to predict antenna selections and/or tuner states. Here, the identifiers of the ideal antennas and/or tuner states are used as labels (e.g., ground truth for the training). Particularly, for an identifier of an ideal antenna and/or an ideal tuner state, the corresponding RSRP measurement group is input to the AI model that then outputs an antenna selection prediction and/or a tuner state selection prediction. Optionally, the corresponding AoA and parameter set are also input such that the AI model also learns from this data. The antenna selection prediction is compared to the identifier of the ideal antenna. The tuner state selection prediction is compared to the identifier of the ideal tuner state. If the comparison results in a match, a reward is computed (e.g., according to a reward function).

Otherwise, a penalty is computed (e.g., according to a penalty function). The parameters of the AI model (e.g., weights of connections between nodes of different layers of the AI model) can be updated based on the penalty and/or reward (e.g., by using a backpropagation algorithm). The training can be iteratively repeated by using different reference measurement groups (and possibly AoAs and parameter sets).

In another example, the AI model is trained to predict AoAs. Here, the documented AoAs are used as labels (e.g., ground truth for the training). Particularly, for a documented AoA, the corresponding RSRP measurement group and/or parameter set is input to the AI model that then outputs a predicted AoA. The predicted AoA is compared to documented AoA. If the comparison results in a match, a reward is computed (e.g., according to a reward function).

Otherwise, a penalty is computed (e.g., according to a penalty function). The parameters of the AI model (e.g., weights of connections between nodes of different layers of the AI model) can be updated based on the penalty and/or reward (e.g., by using a backpropagation algorithm). The training can be iteratively repeated by using different documented AoAs (and possibly RSRP measurement groups and parameter sets).

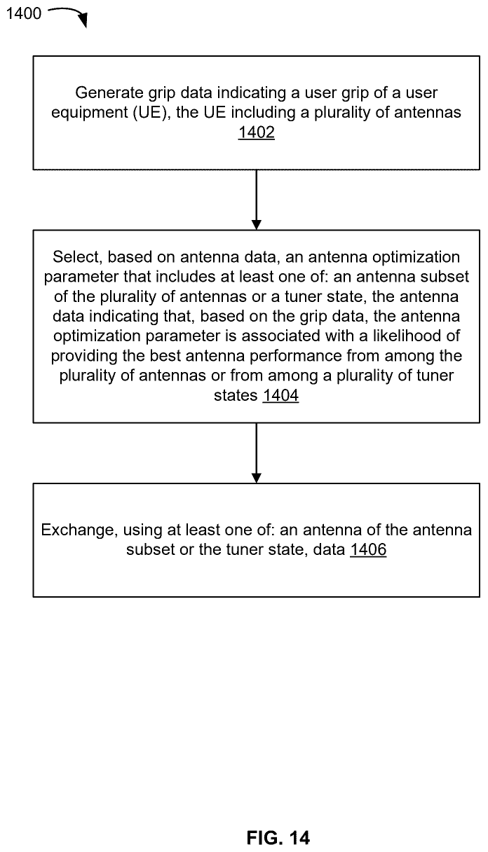

FIG. 14 illustrates an example of an operational flow/algorithmic structure 1400 implemented by a UE (or an apparatus of the UE, where the apparatus includes processing circuitry) to exchange data, in accordance with some embodiments. The UE can be any of the UEs described herein. In some embodiments, the operational flow/algorithmic structure 1400 may be implemented by executing instructions stored in a tangible, non-transitory, computer-readable storage medium, such as a memory of the UE. While the operational flow/algorithmic structure 1400 is described using steps in a specific sequence, it should be understood that the present disclosure contemplates that the described steps may be performed in different sequences than the sequence illustrated, and certain described steps may be omitted or not performed altogether.

In an example, the operational flow/algorithmic structure 1400 includes, at 1402, generating grip data indicating a user grip of a user equipment (UE), the UE including a plurality of antennas. For instance, the grip data can be generated as described in FIG. 8 or FIG. 9.

In an example, the operational flow/algorithmic structure 1400 includes, at 1404, selecting, based on antenna data, an antenna optimization parameter that includes at least one of: an antenna subset of the plurality of antennas or a tuner state, the antenna data indicating that, based on the grip data, the antenna optimization parameter subset is associated with a likelihood of providing the best antenna performance from among the plurality of antennas or from among a plurality of tuner states. For instance, the antenna data corresponds to the antenna data 712 of FIG. 7. This antenna data can be looked up in a manner similar to what is described in FIG. 10. If the look-up results in an antenna subset having more than one antenna and/or in more than one tuner states, the selection techniques of FIG. 10 can also be followed.

In an example, the operational flow/algorithmic structure 1400 includes, at 1406, exchanging, using at least one of: an antenna of the antenna subset or the tuner state. For instance, data is transmitted using resources scheduled on an uplink channel, where the transmission is via the selected antenna. Additionally, or alternatively, data is received using an antenna, where the tuner state controls in part operations of the antenna.

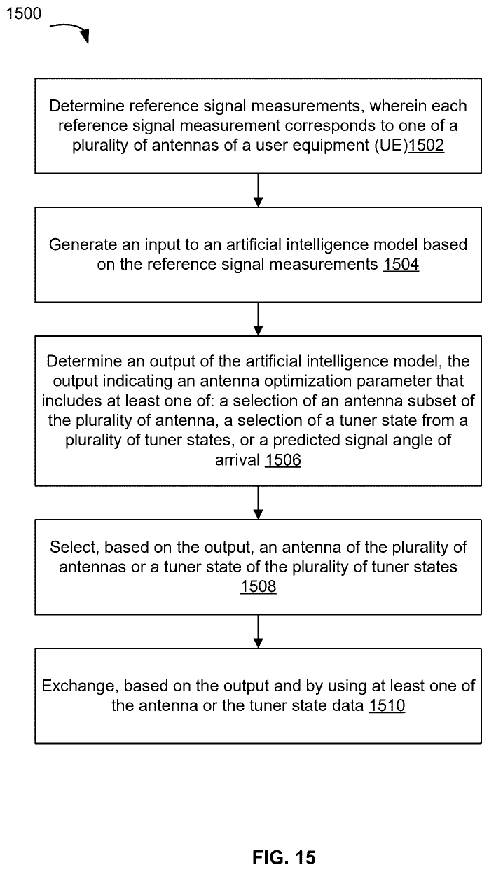

FIG. 15 illustrates another example of an operational flow/algorithmic structure 1500 implemented by a UE (or an apparatus of the UE, where the apparatus includes processing circuitry) to exchange data, in accordance with some embodiments. The UE can be any of the UEs described herein. In some embodiments, the operational flow/algorithmic structure 1500 may be implemented by executing instructions stored in a tangible, non-transitory, computer-readable storage medium, such as a memory of the UE. While the operational flow/algorithmic structure 1500 is described using steps in a specific sequence, it should be understood that the present disclosure contemplates that the described steps may be performed in different sequences than the sequence illustrated, and certain described steps may be omitted or not performed altogether.

In an example, the operational flow/algorithmic structure 1500 includes, at 1502, determining reference signal measurements, wherein each reference signal measurement corresponds to one of a plurality of antennas of a user equipment (UE). For instance, each reference signal measurement is an RSRP measurement corresponding to a reception of a reference signal via one of the antennas.

In an example, the operational flow/algorithmic structure 1500 includes, at 1504, generating an input to an artificial intelligence model based on the reference signal measurements. For instance, the input is generated in a manner similar to what is described in FIG. 11 or FIG. 12.

In an example, the operational flow/algorithmic structure 1500 includes, at 1506, determining an output of the artificial intelligence model, the output indicating an antenna optimization parameter that includes at least one of: a selection of an antenna subset of the plurality of antenna, a selection of a tuner state from a plurality of tuner states, or a predicted signal angle of arrival. Here, the output can be generated by the AI model based on a training of the AI model. The training can be performed in a manner similar to what is described in FIG. 13.

In an example, the operational flow/algorithmic structure 1500 includes, at 1508, selecting, based on the output, an antenna of the plurality of antennas and/or the tuner state of the plurality of tuner states. If the output indicates an antenna selection, the corresponding antenna is selected. If the output indicates a predicted signal AoA, this prediction can be used to look up antenna data and process the look-up result in a manner similar to what is described in FIG. 12, the output indicates a tuner state, the tuner state is selected.

In an example, the operational flow/algorithmic structure 1500 includes, at 1510, exchanging, based on the output and by using at least one of: an antenna of the plurality of antennas or the tuner state, data. For instance, data is transmitted using resources scheduled on an uplink channel, where the transmission is via the selected antenna. Additionally, or alternatively, data is received using an antenna, where the tuner state controls in part operations of the antenna.

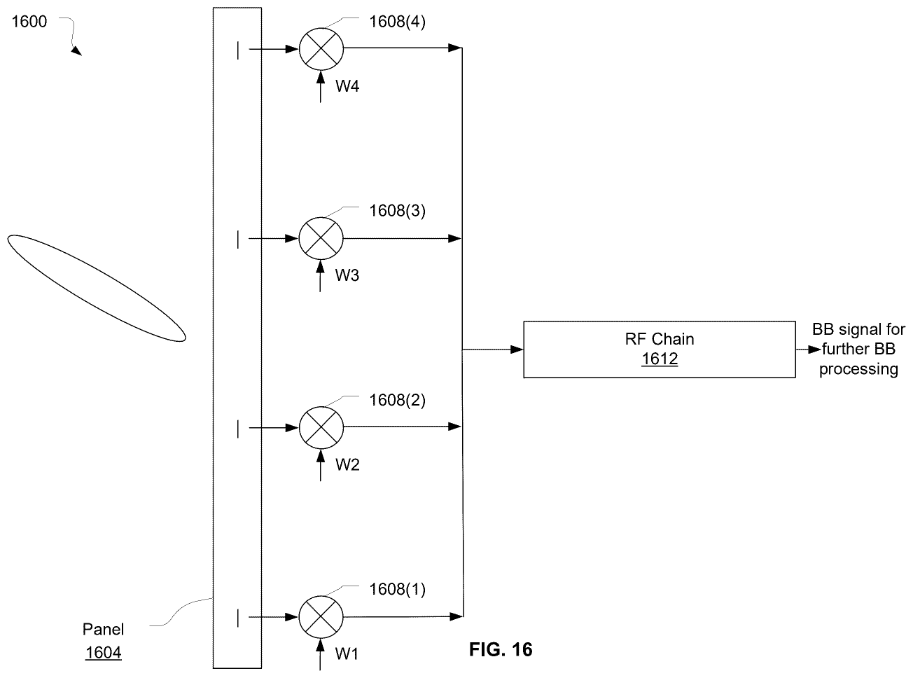

FIG. 16 illustrates receive components 1600 of a UE, such as any of the UE's described herein above, in accordance with some embodiments. The receive components 1600 may include an antenna panel 1604 that includes a number of antenna elements. The panel 1604 is shown with four antenna elements, but other embodiments may include other numbers.

The antenna panel 1604 may be coupled to analog beamforming (BF) components that include a number of phase shifters 1608(1)-1608(4). The phase shifters 1608(1)-1608(4) may be coupled with a radio-frequency (RF) chain 1612. The RF chain 1612 may amplify a receive analog RF signal, down-convert the RF signal to baseband, and convert the analog baseband signal to a digital baseband signal that may be provided to a baseband processor for further processing. In an example, receive components 1600 can include multiple antenna panels 1604 and/or multiple RF chains 1612. An MR can include an antenna panel 1604 and an RF chain 1612. An LP-WUR can include the same antenna panel 1604 or a different antenna panel and a different RF chain 1612.

In various embodiments, control circuitry, which may reside in a baseband processor, may provide BF weights (for example W1-W4), which may represent phase shift values, to the phase shifters 1608(1)-1608(4) to provide a receive beam at the antenna panel 1604. These BF weights may be determined based on the channel-based beamforming.

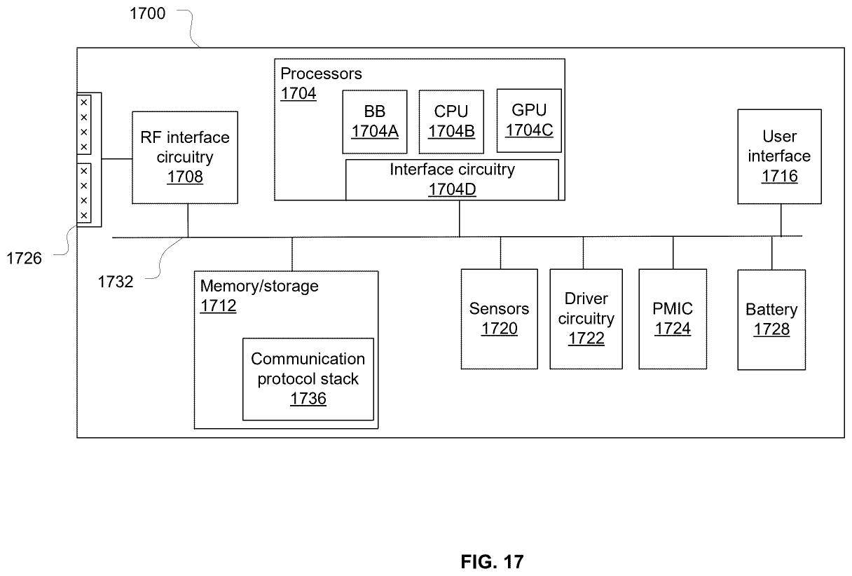

FIG. 17 illustrates a UE 1700, in accordance with some embodiments. The UE 1700 may be similar to and substantially interchangeable with any of the UEs described herein above.

Particularly, the UE 1700 can include multiple antennas and can select one of the antennas for uplink transmission. The selection can be based on a user grip and/or reference signal measurements. The selected antenna can be different from an antenna used for data reception.

Similar to that described above with respect to UE 104, the UE 1700 may be any mobile or non-mobile computing device, such as mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, actuators, etc.), video surveillance/monitoring devices (for example, cameras, video cameras, etc.), wearable devices, or relaxed-IoT devices. In some embodiments, the UE may be a reduced capacity UE or NR-Light UE.

The UE 1700 may include processors 1704, RF interface circuitry 1708, memory/storage 1712, user interface 1716, sensors 1720, driver circuitry 1722, power management integrated circuit (PMIC) 1724, and battery 1728. The processors 1704, or portions thereof, can represent processing circuitry that can be coupled with an RF chain to form an MR or the LP-WUR. The components of the UE 1700 may be implemented as integrated circuits (ICs), portions thereof, discrete electronic devices, or other modules, logic, hardware, software, firmware, or a combination thereof. The block diagram of FIG. 17 is intended to show a high-level view of some of the components of the UE 1700. However, some of the components shown may be omitted, additional components may be present, and different arrangements of the components shown may occur in other implementations.

The components of the UE 1700 may be coupled with various other components over one or more interconnects 1732, which may represent any type of interface, input/output, bus (local, system, or expansion), transmission line, trace, optical connection, etc. that allows various circuit components (on common or different chips or chipsets) to interact with one another.

The processors 1704 may include processor circuitry, such as baseband processor circuitry (BB) 1704A, central processor unit circuitry (CPU) 1704B, and graphics processor unit circuitry (GPU) 1704C. The processors 1704 may include any type of circuitry or processor circuitry that executes or otherwise operates computer-executable instructions, such as program code, software modules, or functional processes from memory/storage 1712 to cause the UE 1700 to perform operations as described herein.

In some embodiments, the baseband processor circuitry 1704A may access a communication protocol stack 1736 in the memory/storage 1712 to communicate over a 3GPP compatible network. In general, the baseband processor circuitry 1704A may access the communication protocol stack to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a non-access stratum “NAS” layer. In some embodiments, the PHY layer operations may additionally/alternatively be performed by the components of the RF interface circuitry 1708.

The baseband processor circuitry 1704A may generate or process baseband signals or waveforms that carry information in 3GPP-compatible networks. In some embodiments, the waveforms for NR may be based on cyclic prefix OFDM (CP-OFDM) in the uplink or downlink, and discrete Fourier transform spread OFDM (DFT-S-OFDM) in the uplink.

The baseband processor circuitry 1704A may also access group information from memory/storage 1712 to determine search space groups in which a number of repetitions of a PDCCH may be transmitted.

The memory/storage 1712 may include any type of volatile or non-volatile memory that may be distributed throughout the UE 1700. In some embodiments, some of the memory/storage 1712 may be located on the processors 1704 themselves (for example, L1 and L2 cache), while other memory/storage 1712 is external to the processors 1704 but accessible thereto via a memory interface. The memory/storage 1712 may include any suitable volatile or non-volatile memory, such as, but not limited to, dynamic random-access memory (DRAM), static random-access memory (SRAM), erasable programmable read-only memory (EPROM), electrically erasable programmable read-only memory (EEPROM), Flash memory, solid-state memory, or any other type of memory device technology.

The RF interface circuitry 1708 may include transceiver circuitry and a radio frequency front module (RFEM) that allows the UE 1700 to communicate with other devices over a radio access network. The RF interface circuitry 1708 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via an antenna 1750 and proceed to filter and amplify (with a low-noise amplifier) the signal. The signal may be provided to a receiver of the transceiver that down-converts the RF signal into a baseband signal that is provided to the baseband processor of the processors 1704.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 1750.

In various embodiments, the RF interface circuitry 1708 may be configured to transmit/receive signals in a manner compatible with NR access technologies.

The antenna 1750 may include a number of antenna elements that each convert electrical signals into radio waves to travel through the air and to convert received radio waves into electrical signals. The antenna elements may be arranged into one or more antenna panels. The antenna 1750 may have antenna panels that are omnidirectional, directional, or a combination thereof to enable beamforming and multiple input, multiple output communications. The antenna 1750 may include microstrip antennas, printed antennas fabricated on the surface of one or more printed circuit boards, patch antennas, phased array antennas, etc. The antenna 1750 may have one or more panels designed for specific frequency bands including bands in FR1 or FR2.

The user interface circuitry 1716 includes various input/output (I/O) devices designed to enable user interaction with the UE 1700. The user interface 1716 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators, such as light emitting diodes (LEDs) and multi-character visual outputs, or more complex outputs, such as display devices or touchscreens (for example, liquid crystal displays (LCDs), LED displays, quantum dot displays, projectors, etc.), with the output of characters, graphics, multimedia objects, and the like being generated or produced from the operation of the UE 1700.

The sensors 1720 may include devices, modules, or subsystems whose purpose is to detect events or changes in its environment and send the information (sensor data) about the detected events to some other device, module, subsystem, etc. Examples of such sensors include, inter alia, inertia measurement units comprising accelerometers; gyroscopes; or magnetometers; microelectromechanical systems or nanoelectromechanical systems comprising 3-axis accelerometers; 3-axis gyroscopes; or magnetometers; level sensors; flow sensors; temperature sensors (for example, thermistors); pressure sensors; barometric pressure sensors; gravimeters; altimeters; image capture devices (for example; cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 1722 may include software and hardware elements that operate to control particular devices that are embedded in the UE 1700, attached to the UE 1700, or otherwise communicatively coupled with the UE 1700. The driver circuitry 1722 may include individual drivers allowing other components to interact with or control various input/output (I/O) devices that may be present within, or connected to, the UE 1700. For example, driver circuitry 1722 may include a display driver to control and allow access to a display device, a touchscreen driver to control and allow access to a touchscreen interface, sensor drivers to obtain sensor readings of sensor circuitry 1720 and control and allow access to sensor circuitry 1720, drivers to obtain actuator positions of electro-mechanic components or control and allow access to the electro-mechanic components, a camera driver to control and allow access to an embedded image capture device, audio drivers to control and allow access to one or more audio devices.

The PMIC 1724 may manage power provided to various components of the UE 1700. In particular, with respect to the processors 1704, the PMIC 1724 may control power-source selection, voltage scaling, battery charging, or DC-to-DC conversion.

In some embodiments, the PMIC 1724 may control, or otherwise be part of, various power saving mechanisms of the UE 1700. For example, if the platform UE is in an RRC_Connected state, where it is still connected to the RAN node as it expects to receive traffic shortly, then it may enter a state known as Discontinuous Reception Mode (DRX) after a period of inactivity. During this state, the UE 1700 may power down for brief intervals of time and thus save power. If there is no data traffic activity for an extended period of time, then the UE 1700 may transition off to an RRC_Idle state, where it disconnects from the network and does not perform operations, such as channel quality feedback, handover, etc. The UE 1700 goes into a very low power state and it performs paging where again it periodically wakes up to listen to the network and then powers down again. The UE 1700 may not receive data in this state; in order to receive data, it must transition back to RRC_Connected state. An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

A battery 1728 may power the UE 1700, although in some examples the UE 1700 may be mounted deployed in a fixed location and may have a power supply coupled to an electrical grid. The battery 1728 may be a lithium-ion battery, a metal-air battery, such as a zinc-air battery, an aluminum-air battery, a lithium-air battery, and the like. In some implementations, such as in vehicle-based applications, the battery 1728 may be a typical lead-acid automotive battery.

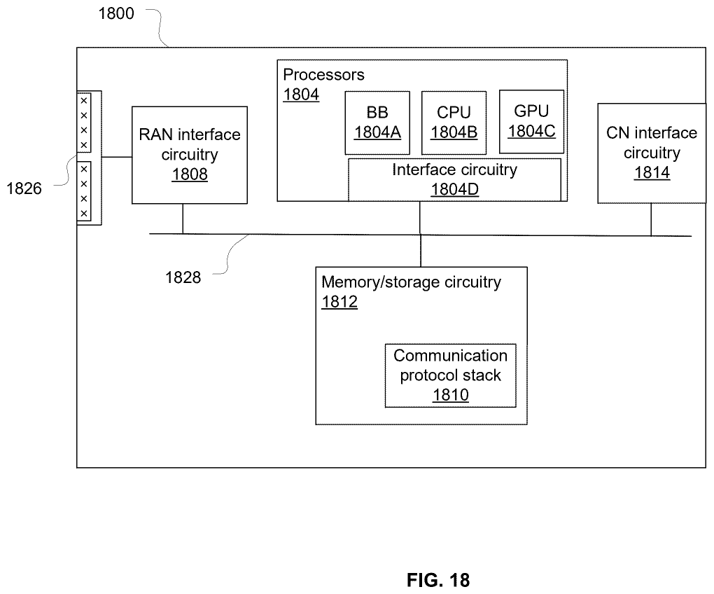

FIG. 18 illustrates a base station 1800, in accordance with some embodiments. The base station 1800 may be similar to and substantially interchangeable with the base station 108 of FIG. 1 and other base stations described herein above. Particularly, the base station 1800 can send reference signals to a UE to enable a selection of an antenna by the UE for uplink transmission.

The base station 1800 may include processors 1804, RAN interface circuitry 1808, core network (CN) interface circuitry 1812, and memory/storage circuitry 1816.

The components of the base station 1800 may be coupled with various other components over one or more interconnects 1828.

The processors 1804, RAN interface circuitry 1808, memory/storage circuitry 1816 (including communication protocol stack 1810), antenna 1850, and interconnects 1828 may be similar to like-named elements shown and described with respect to FIG. 17.

The CN interface circuitry 1812 may provide connectivity to a core network, for example, a Fifth Generation Core network (5GC) using a 5GC-compatible network interface protocol, such as carrier Ethernet protocols, or some other suitable protocol. Network connectivity may be provided to/from the base station 1800 via a fiber optic or wireless backhaul. The CN interface circuitry 1812 may include one or more dedicated processors or FPGAs to communicate using one or more of the aforementioned protocols. In some implementations, the CN interface circuitry 1812 may include multiple controllers to provide connectivity to other networks using the same or different protocols.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### Examples

In the following sections, further exemplary embodiments are provided.
Example 1 includes a method comprising: receiving generating grip data indicating a user grip of a user equipment (UE), the UE including a plurality of antennas; selecting, based on antenna data, an antenna optimization parameter that includes at least one of: an antenna subset of the plurality of antennas or a tuner state, the antenna data indicating that, based on the grip data, the antenna optimization parameter is associated with a likelihood of providing the best antenna performance from among the plurality of antennas or from among a plurality of tuner states; and exchanging, using at least one of: an antenna of the antenna subset or the tuner state, data.
Example 2 includes a method comprising: receiving network data by using a first antenna of a plurality of antennas of the UE; generating grip data indicating a user grip of the UE; selecting, based on antenna data, an antenna optimization parameter that includes at least one of: an antenna subset of the plurality of antennas or a tuner state, the antenna data indicating that, based on the grip data, the antenna optimization parameter is associated with a likelihood of providing the best antenna performance from among the plurality of antennas or from among a plurality of tuner states; selecting a second antenna of the antenna subset, the second antenna being the same as or different from the first antenna; and exchanging, using at least one of: the second antenna or the tuner state for the first antenna, data.
Example 3 includes the method of any example 1-2, wherein the user grip is one of candidate user grips, wherein the candidate user grips include: a non-grip, a double-hands grip, a landscape grip, and a portrait grip.
Example 4 includes the method of example 3, wherein the landscape grip is one of a left-hand landscape grip or a landscape right-hand grip, and wherein the portrait grip includes a left-hand portrait grip or a right-hand portrait grip.
Example 5 includes the method of any example 1-4, wherein the user grip is one of candidate user grips, wherein the antenna data associates, each one of the candidate user grips, with a corresponding antenna subset of the plurality of antennas.
Example 6 includes the method of example 5, wherein at least two antenna subsets indicated by the antenna data differ by at least one antenna.
Example 7 includes the method of any example 1-6, wherein the antenna data corresponds to possible antenna selections across different signal angle of arrivals.
Example 8 includes the method of any example 1-7, wherein the antenna data is generated based on a simulation of an antenna selection per signal angle of arrival.
Example 9 includes the method of example 8, wherein the simulation indicates, for each antenna of the plurality of antennas, a corresponding likelihood of being selected across different signal angle of arrivals.
Example 10 includes the method of example 9, wherein the corresponding likelihood of each antenna is specific to a UE type, frequency band, and candidate user grip.
Example 11 includes the method of any example 1-10, wherein the antenna optimization parameter is selected further based on a type of the UE and a frequency band of the transmitting, wherein the likelihood is further associated in the antenna data with the type and the frequency band.
Example 12 includes the method of any example 1-11, wherein the antenna subset includes a first antenna and a second antenna of the plurality of antennas, and wherein the method further comprises: determining a first reference signal measurement corresponding to the first antenna and a second reference signal measurement corresponding to the second antenna; determining a first maximum transmit power level (MTPL) correspond to the first antenna and a second maximum transmit power level (MTPL) corresponds to the second antenna; and selecting the antenna optimization parameter based on the first reference signal measurement, the second reference signal measurement, the first maximum transmit power level, and the second maximum transmit power level.
Example 13 includes the method of example 12, wherein the first reference signal measurement includes at least one of: a first reference signal received power (RSRP) measured based on a first reception of a reference signal by the first antenna, a first received signal strength indicator (RSSI) measured based on the first reception, or a first signal to interference and noise ratio (SINR) measured based on the first reception, and wherein the second reference signal measurement includes at least one of: a second RSRP measured based on a second reception of the reference signal by the second antenna, a second RSSI measured based on the second reception, or a second SINR measured based on the reception.
Example 14 includes the method of example 12, wherein the second antenna is selected as the antenna based on a difference between the second reference signal measurement and the first reference signal measurement being larger than a difference between the first maximum transmit power level and the second maximum transmit power level.
Example 15 includes the method of any example 1-14, wherein the antenna data includes, for each antenna that belongs to the antenna subset, a bias offset relative to one or more remaining antennas excluded from the antenna subset.
Example 16 includes the method of any example 1-15, wherein the grip data is generated based on an output of an operating system of the UE or an application executing on the UE and generating the data, and wherein the output indicates whether the UE is being used in a non-grip, a double-hands grip, a landscape grip, and a portrait grip.
Example 17 includes the method of example 16, wherein the grip data is further generated based on a reference signal measurement for each one of the plurality of antennas and indicates a left-hand landscape grip, a landscape right-hand grip, a left-hand portrait grip, a right-hand portrait grip, or a non-grip.
Example 18 includes the method of any example 1-17, wherein the grip data is generated based on an input to an artificial intelligence model, wherein the input is generated based on signal measurements corresponding to the plurality of antennas.
Example 19 includes the method of example 18, wherein the input includes a measurement of interference between a transmit antenna and a receive antenna of the plurality of antennas.
Example 20 include a method comprising: determining reference signal measurements, wherein each reference signal measurement corresponds to one of a plurality of antennas of a user equipment (UE); generating an input to an artificial intelligence model based on the reference signal measurements; determining an output of the artificial intelligence model, the output indicating an antenna optimization parameter that includes at least one of: a selection of an antenna subset of the plurality of antenna, a selection of a tuner state from a plurality of tuner states, or a predicted signal angle of arrival; and exchanging, based on the output and by using at least one of: an antenna of the plurality of antennas or the tuner state, data.
Example 21 include a method comprising: receiving network data by using a first antenna of a plurality of antennas of the UE; determining reference signal measurements, wherein each reference signal measurement corresponds to one of the plurality of antennas; generating an input to an artificial intelligence model based on the reference signal measurements; determining an output of the artificial intelligence model, the output indicating at least one of: a selection of an antenna subset of the plurality of antenna, a tuner state of a plurality of tuner states, or a predicted signal angle of arrival; selecting, based on the output, a second antenna of the plurality of antennas, the second antenna being the same as or different from the first antenna; and exchanging, based on the output and by using at least one of: the second antenna or the tuner state for the first antenna, data.
Example 22 includes the method of any example 20-21, wherein the method further comprises: generating grip data indicating a user grip of the UE, wherein the input is further generated based on the grip data.
Example 23 includes the method of example 22, wherein the input is further generated based on a frequency band of the transmitting and a type of the UE.
Example 24 includes the method of example 23, wherein the input includes the reference signal measurements, the grip data, an identifier of the frequency band, and the type of the UE.
Example 25 includes the method of example 22, wherein the grip data indicates one of candidate user grips, wherein the candidate user grips include: a non-grip, a double-hands grip, a landscape grip, and a portrait grip.
Example 26 includes the method of example 25, wherein the landscape grip is one of a left-hand landscape grip or a landscape right-hand grip, and wherein the portrait grip includes a left-hand portrait grip or a right-hand portrait grip.
Example 27 includes the method of any example 20-26, wherein the reference signal measurements include at least: a first reference signal received power (RSRP) measured based on a first reception of a reference signal by a first antenna of the plurality of antennas, a first received signal strength indicator (RSSI) measured based on the first reception, or a first signal to interference and noise ratio (SINR) measured based on the first reception, and wherein the reference signal measurements further include at least one of: a second RSRP measured based on a second reception of the reference signal by a second antenna of the plurality of antennas, a second RSSI measured based on the second reception, or a second SINR measured based on the reception.
Example 28 includes the method of any example 20-27, wherein the output of the artificial intelligence model indicates that the antenna is to be selected from among the plurality of antennas.
Example 29 includes the method of any example 20-28, wherein the output of the artificial intelligence model indicates the antenna subset, wherein the antenna subset is associated with a likelihood of providing the best antenna performance from among the plurality of antennas.
Example 30 includes the method of example 29, wherein a first antenna and a second antenna of the plurality of antennas belong to the antenna subset, and wherein the method further comprises: determining a first reference signal measurement corresponding to the first antenna and a second reference signal measurement corresponding to the second antenna; and selecting the antenna as one of the first antenna or the second antenna based on the first reference signal measurement and the second reference signal measurement.
Example 31 includes the method of example 30, further comprising: determining a first maximum transmit power level correspond to the first antenna and a second maximum transmit power level corresponds to the second antenna, wherein the antenna is selected further based on the first maximum transmit power level and the second maximum transmit power level.
Example 32 includes the method of example 31, wherein the second antenna is selected as the antenna based on a difference between the second reference signal measurement and the first reference signal measurement being larger than a difference between the first maximum transmit power level and the second maximum transmit power level.
Example 33 includes the method of any example 20-32, wherein the output of the artificial intelligence model indicates the predicted signal angle of arrival, and wherein the antenna is selected based on antenna data that associates the predicted signal angle of arrival with the antenna.
Example 34 includes the method of example 33, wherein the antenna data associates each one of candidate signal angle of arrivals with a corresponding antenna selection.
Example 35 includes the method of example 34, wherein the antenna data further associates each one of candidate signal angle of arrivals with at least one of: a corresponding user grip, a UE type, or a corresponding frequency band.
Example 36 includes the method of any example 20-35, wherein the output of the artificial intelligence model is generated further based on grip data, wherein the grip data is generated based on an output of an operating system of the UE or an application executing on the UE and generating the data and based on the reference signal measurements.
Example 37 includes the method of any example 20-36, wherein the artificial intelligence model is a first artificial intelligence model, wherein the input to the first artificial intelligence model includes the reference signal measurements and grip data indicating a user grip of the UE.
Example 38 includes the method of example 37, wherein the grip data is output of a second artificial intelligence model based on a measurement of interference between a transmit antenna and a receive antenna of the plurality of antennas.
Example 39 includes a user equipment (UE) or an apparatus comprising: one or more processors; and one or more memory storing instructions that, upon execution by the one or more processors, configure the UE or the apparatus to perform a method described in or related to any of the preceding examples.
Example 40 includes one or more computer-readable media storing instructions that, when executed on a user equipment (UE) or an apparatus, cause the UE or the apparatus to perform operations comprising one or more elements of a method described in or related to any of the preceding examples.
Example 41 includes an apparatus comprising means to perform one or more elements of a method described in or related to any of the preceding examples.
Example 42 includes one or more non-transitory computer-readable media comprising instructions to cause an apparatus, upon execution of the instructions by one or more processors of the apparatus, to perform one or more elements of a method described in or related to any of the preceding examples.
Example 43 includes an apparatus comprising logic, modules, or processing circuitry configured to perform one or more elements of a method described in or related to any of the preceding examples.
Example 44 includes an apparatus, a network, a base station, or a system comprising: one or more processors and one or more computer-readable media comprising instructions that, when executed by the one or more processors, cause the one or more processors to perform one or more elements of a method described in or related to any of the preceding examples.

Any of the above-described examples may be combined with any other example (or combination of examples), unless explicitly stated otherwise. The foregoing description of one or more implementations provides illustration and description but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1. A method comprising:
generating grip data indicating a user grip of a user equipment (UE), the UE including a plurality of antennas;
selecting, based on antenna data, an antenna optimization parameter that includes at least one of: an antenna subset of the plurality of antennas or a tuner state, the antenna data indicating that, based on the grip data, the antenna optimization parameter is associated with a likelihood of providing the best antenna performance from among the plurality of antennas or from among a plurality of tuner states; and
exchanging, using at least one of: an antenna of the antenna subset or the tuner state, data.

2. The method of claim 1, wherein the user grip is one of candidate user grips, wherein the candidate user grips include: a non-grip, a double-hands grip, a landscape grip, and a portrait grip.

3. The method of claim 2, wherein the landscape grip is one of a left-hand landscape grip or a landscape right-hand grip, and wherein the portrait grip includes a left-hand portrait grip or a right-hand portrait grip.

4. The method of claim 1, wherein the user grip is one of candidate user grips, wherein the antenna data associates, each one of the candidate user grips, with a corresponding antenna subset of the plurality of antennas.

5. The method of claim 4, wherein at least two antenna subsets indicated by the antenna data differ by at least one antenna.

6. The method of claim 1, wherein the antenna data corresponds to possible antenna selections across different signal angle of arrivals.

7. The method of claim 1, wherein the antenna data is generated based on a simulation of an antenna selection per signal angle of arrival.

8. The method of claim 7, wherein the simulation indicates, for each antenna of the plurality of antennas, a corresponding likelihood of being selected across different signal angle of arrivals.

9. The method of claim 8, wherein the corresponding likelihood of each antenna is specific to a UE type, frequency band, and candidate user grip.

10. The method of claim 1, wherein the antenna optimization parameter is selected further based on a type of the UE and a frequency band of the transmitting, wherein the likelihood is further associated in the antenna data with the type and the frequency band.

11. An apparatus comprising:
processing circuitry configured to be communicatively coupled to a plurality of antennas and further configured to:
generate grip data indicating a user grip;
select, based on antenna data, an antenna optimization parameter that includes at least one of: an antenna subset of the plurality of antennas or a tuner state, the antenna data indicating that, based on the grip data, the antenna optimization parameter is associated with a likelihood of providing the best antenna performance from among the plurality of antennas or from among a plurality of tuner states; and
exchange, using at least one of: an antenna of the antenna subset or the tuner state, data.

12. The apparatus of claim 11, wherein the antenna subset includes a first antenna and a second antenna of the plurality of antennas, and wherein the processing circuitry is further configured to:
determine a first reference signal measurement corresponding to the first antenna and a second reference signal measurement corresponding to the second antenna;
determine a first maximum transmit power level (MTPL) correspond to the first antenna and a second maximum transmit power level (MTPL) corresponds to the second antenna; and
select the antenna optimization parameter based on the first reference signal measurement, the second reference signal measurement, the first maximum transmit power level, and the second maximum transmit power level.

13. The apparatus of claim 12, wherein the first reference signal measurement includes at least one of: a first reference signal received power (RSRP) measured based on a first reception of a reference signal by the first antenna, a first received signal strength indicator (RSSI) measured based on the first reception, or a first signal to interference and noise ratio (SINR) measured based on the first reception, and wherein the second reference signal measurement includes at least one of: a second RSRP measured based on a second reception of the reference signal by the second antenna, a second RSSI measured based on the second reception, or a second SINR measured based on the reception.

14. The apparatus of claim 12, wherein the second antenna is selected as the antenna based on a difference between the second reference signal measurement and the first reference signal measurement being larger than a difference between the first maximum transmit power level and the second maximum transmit power level.

15. The apparatus of claim 11, wherein the antenna data includes, for each antenna that belongs to the antenna subset, a bias offset relative to one or more remaining antennas excluded from the antenna subset.

16. One or more computer-readable storage media storing instructions that, upon execution at a user equipment (UE), configure the UE to perform operations comprising:
receiving network data by using a first antenna of a plurality of antennas of the UE;
generating grip data indicating a user grip of the UE;
selecting, based on antenna data, an antenna optimization parameter that includes at least one of: an antenna subset of the plurality of antennas or a tuner state, the antenna data indicating that, based on the grip data, the antenna optimization parameter is associated with a likelihood of providing the best antenna performance from among the plurality of antennas or from among a plurality of tuner states;
selecting a second antenna of the antenna subset, the second antenna being the same as or different from the first antenna; and
exchanging, using at least one of: the second antenna or the tuner state for the first antenna, data.

17. The one or more computer-readable storage media of claim 16, wherein the grip data is generated based on an output of an operating system of the UE or an application executing on the UE and generating the data, and wherein the output indicates whether the UE is being used in a non-grip, a double-hands grip, a landscape grip, and a portrait grip.

18. The one or more computer-readable storage media of claim 17, wherein the grip data is further generated based on a reference signal measurement for each one of the plurality of antennas and indicates a left-hand landscape grip, a landscape right-hand grip, a left-hand portrait grip, a right-hand portrait grip, or a non-grip.

19. The one or more computer-readable storage media of claim 16, wherein the grip data is generated based on an input to an artificial intelligence model, wherein the input is generated based on signal measurements corresponding to the plurality of antennas.

20. The one or more computer-readable storage media of claim 19, wherein the input includes a measurement of interference between a transmit antenna and a receive antenna of the plurality of antennas.
